(19) United States
(12) Patent Application Publication
(10) Pub. No.: US 2014/0045164 A1
(43) Pub. Date: Feb. 13, 2014

(54) METHODS AND APPARATUS FOR ASSESSING AND PROMOTING LEARNING

(71) Applicant: Proving Ground LLC, Fountain Hills, AZ (US)

(72) Inventor: Sean Kearns, Fountain Hills, AZ (US)

(21) Appl. No.: 14/059,536

(22) Filed: Oct. 22, 2013

Related U.S. Application Data
(63) Continuation-in-part of application No. 13/838,049, filed on Mar. 15, 2013.
Application No. 13/838,049 is a continuation-in-part of application No. 13/345,501, filed on Jan. 6, 2012.
(60) Provisional application No. 61/617,863, filed on Mar. 30, 2012.
(60) Provisional application No. 61/646,485, filed on May 14, 2012.

(51) Int. Cl. G09B 7/06

(52) U.S. Cl. CPC G09B 7/06
USPC 434/353

(57) ABSTRACT

Methods and apparatus for assessing and promoting learning according to various aspects of the present technology generally comprise presenting a training system to a user that adapts to the user's progress by altering how a training assignment is presented to the user by monitoring the user's progression toward a desired completion criterion. The training system may determine a user's proficiency with the subject matter without a formal or standardized test.

### CROSS-REFERENCES TO RELATED APPLICATIONS

This application is a continuation-in-part of U.S. patent application Ser. No. 13/838,049, filed on Mar. 15, 2013, entitled METHODS AND APPARATUS FOR DYNAMIC TRAINING AND FEEDBACK, which is a continuation-in-part of U.S. patent application Ser. No. 13/345,501, filed on Jan. 6, 2012, entitled METHODS AND APPARATUS FOR DYNAMIC TRAINING; and which claims the benefit of U.S. Provisional Patent Application No. 61/617,863, filed Mar. 30, 2012, entitled METHODS AND APPARATUS FOR DYNAMIC TRAINING AND FEEDBACK; and U.S. Provisional Patent Application No. 61/646,485, filed May 14, 2012, entitled METHODS AND APPARATUS FOR LEARNING; and incorporates the disclosure of each application by reference. To the extent that the present disclosure conflicts with any referenced application, however, the present disclosure is to be given priority.

### BACKGROUND OF THE INVENTION

Classroom training, one-on-one coaching, seminars, best-practices discussions, and traditional studying have been the primary methods of providing education and training. Each of these traditional methods, although somewhat effective, fails to provide an efficient way to achieve the context-specific repetition and application necessary for developing long-term memories and skills. The progress of a trainee participating in a traditional method of learning is usually measured subjectively, and objective measures of progress are difficult to obtain.

Multiple choice questions are often preferred as a testing method because they tend to be objective. However, the reliability and validity of multiple choice questions are limited by the phenomenon of “cueing,” where a person's answer choice is influenced, positively or negatively, by reading the potential answer choices first. The reliability and validity of multiple choice questions are also limited by testing techniques a person can employ to allow them to eliminate one or more potential answers as incorrect. Therefore, traditional multiple choice tests may not accurately measure a person's level of proficiency with the tested subject matter. In addition, a traditional test given after teaching the relevant subject matter is often not an effective means of assessment because it is a snapshot of a person's performance on a small subset of questions.

### SUMMARY OF THE INVENTION

Methods and apparatus for assessing and promoting learning according to various aspects of the present technology generally comprise presenting a training system to a user that adapts to the user's progress by altering how a training assignment is presented to the user by monitoring the user's progression toward a desired completion criterion. The training system may determine a user's proficiency with the subject matter without a formal or standardized test.

### BRIEF DESCRIPTION OF THE DRAWING FIGURES

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a training system;

FIG. 2 is a block diagram of a client system;

FIG. 3A is a block diagram representing a client system running the training system;

FIG. 3B is a block diagram representing a client system running a training system that utilizes a content database located a remote server;

FIG. 3C is a block diagram representing a client system running an application that accesses the training system that utilizes a content database located a remote server;

FIG. 4 representatively illustrates a visual layout of testing system;

FIG. 5 representatively illustrates a visual layout of the testing system including an interactive feature;

FIG. 6 representatively illustrates an interactive summary window;

FIGS. 7A and 7B representatively illustrate visual layouts of the testing system including icons;

FIG. 8 representatively illustrates a presentation of training progress;

FIGS. 9A-9E representatively illustrate an icon associated with a skill to be developed;

FIG. 10 representatively illustrates a group of icons;

FIG. 11 representatively illustrates a group of icons representing that the user is proficient for a training course;

FIG. 12 representatively illustrates a skyline view comprising multiple groups of icons arranged according to topic.

FIG. 13 representatively illustrates a hierarchy of skills represented as a skill building;

FIG. 14 representatively illustrated multiple choice questions organized in an exemplary database structure;

FIG. 15 representatively illustrates a training system method;

FIG. 16 is an exemplary embodiment of a portion of a training system method;

FIG. 17 representatively illustrates a visual layout of the testing system including floor and game scores;

FIG. 18 representatively illustrates a visual layout of the testing system including a representation of habit scores;

FIGS. 19A-19E representatively illustrate an icon representing a habit score; and

FIGS. 20A-20C representatively illustrate a multiple choice question presented with a testing window.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ systems, technologies, algorithms, designs, and the like, which may carry out a variety of functions. In addition, the present technology may be practiced in conjunction with any number of hardware and software applications and environments, and the system described is merely one exemplary application for the invention. Software and/or software elements according to various aspects of the present technology may be implemented with any programming or scripting language or standard, such as, for example, HL7, AJAX, C, C++, Java, COBOL, assembly, PERL, eXtensible Markup Language (XML), PHP, etc., or any other programming and/or scripting language, whether now known or later developed.

The present technology may also involve multiple programs, functions, computers and/or servers. While the exemplary embodiments are described in conjunction with conventional computers, the various elements and processes may be implemented in hardware, software, or a combination of hardware, software, and other systems. Further, the present technology may employ any number of conventional techniques for presenting training material, testing training participants, rendering content, displaying objects, communicating information, interacting with a user, gathering data, managing training programs, usage tracking, calculating statistics, and the like.

For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Methods and apparatus for assessing and promoting learning according to various aspects of the present technology may operate in conjunction with any suitable display, computing process or machine, interactive system, and/or testing environment. Various representative implementations of the present technology may be applied to any system for creating, administering, scoring, optimizing, displaying, coordinating, and tracking the training material and the use thereof. Certain representative implementations may comprise, for example, methods or systems for presenting training material on a display device.

A training system according to various aspects of the present technology may facilitate learning of training material and provide a more accurate assessment of a user's proficiency with the training material, without the need for a traditional end-of-training assessment (such as a test). A training system according to various aspects of the present technology may adapt to the user's proficiency level, making the training more difficult as the user's proficiency increases. A training system according to various aspects of the present technology may increase or decrease the difficulty by incorporating one or more modifications (or filters) to the training material.

For example, the training system may initially present multiple choice questions with the potential answers shown, but as the user increases in proficiency past a certain point, the training system may start to present multiple choice questions with the potential answers hidden, and may only show the potential answers for a short period of time. In this example, as the user increases in proficiency, they will have to formulate the correct answer to the multiple choice question before viewing the potential answers. Because the training system adapts to the user, once the user reaches a certain level of proficiency, the user can confidently be judged to have the skills the training material was intended to teach. A training system according to various aspects of the present invention may therefore be more game-like, in that it adapts to the user and eliminates the need for a final test.

A training system may comprise a system designed to provide a user with relevant training material, simulators, and testing devices designed to help the user learn information, learn or improve skills, develop concepts, engage in job training, and the like. The training system may also provide a system for allowing the user to access training material and a simulator for practicing learned skills, and a testing system to demonstrate proficiency with the learned skills. In one embodiment, the simulator may determine whether the user has demonstrated proficiency with the learned skills. Skills may also be referred to as habits or behaviors. The training system may further be adapted to divide users into one or more groups based upon any relevant factor such as teams, geographic location, region, district, supervising manager, company divisions, job type, job code, company, and the like. Training programs may be customized based upon a particular group's needs. Methods and apparatus according to various aspects of the present invention may provide an objective measure of a user's progress through the training material.

An administrator, such as an employer or a teacher, may elect to require a training course. The administrator may select the various training material for that course. For example, the administrator may require a training course on a new sales technique. The training material may comprise a general description of the sales technique, how and when to implement the sales technique, case studies that test a user's mastery of the new technique, and one or more skills associated therewith. The administrator may select the various parameters of how the training will take place. For example, the administrator may require the course to be completed in a certain amount of time and/or the minimum score the user must achieve to pass the course. The training material may be divided into various sections and questions, case studies, answers, and explanations may be created.

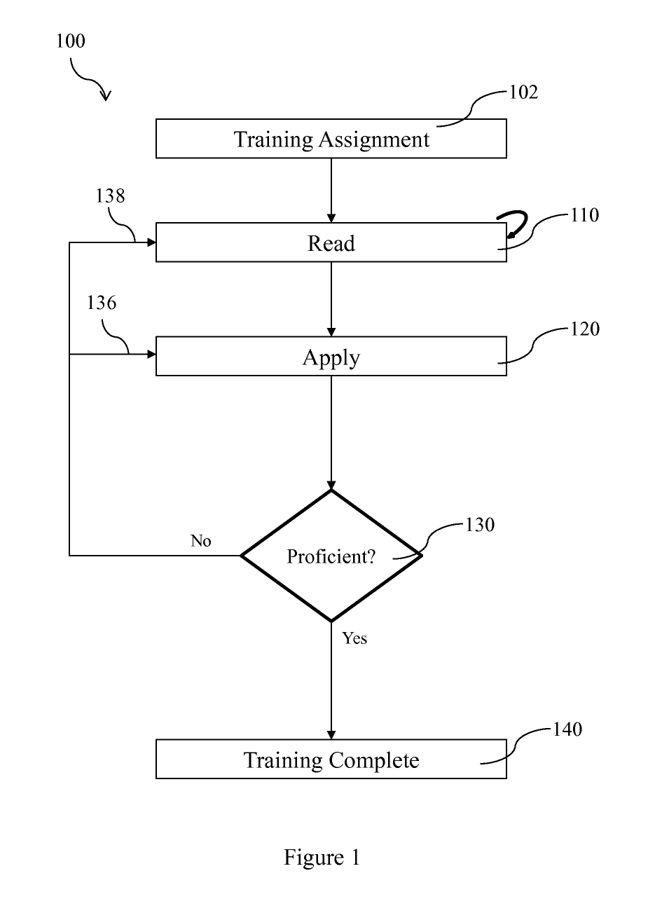

For example, referring to FIG. 1, the training system 100 may comprise a read section 110 and an apply section 120. The training material for each section may be selected and/or created by the administrator. The training material may correspond to a particular training course to be administered to one or more users. After the user has been assigned a training assignment 102, the user may start the training by entering and completing the read section 110. Upon the completion of the read section 110, the user may elect whether to continue reviewing the material in the read section 110 or continue onto the apply section 120. The apply section 120 may assess the user's proficiency with the training material and may determine (130) if the training should be deemed complete based on the user's proficiency. Once the training is complete 140, the administrator may be notified. If the user is determined (130) not to be proficient, the user may attempt (136) the apply section 120 to continue the assessment, or may return (138) to the read section 110. In this exemplary embodiment, no final test is necessary to determine if the user is proficient with the material. In an alternative embodiment, a certify section may be placed after the apply section. Administering the training material may comprise presenting the training material to the user in the read section 110 and the apply section 120.

In one embodiment, the training system 100 may be remotely accessed by the administrator. The administrator may view the user's progress through the various sections as well as the user's performance. In one embodiment, the administrator may also adjust parameters, such as adjusting deadlines and required scores for completing training. The administrator may also adjust the training material by adding new material, deleting material, and/or editing material.

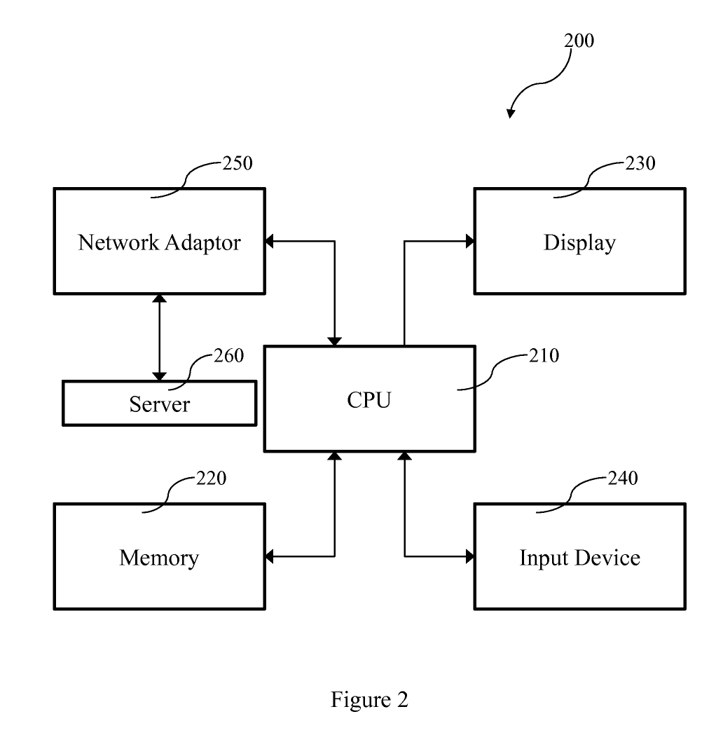

The training system 100 may be configured to be accessed by, or run on, a client system. The client system may comprise any suitable system or device such as a personal computer, smart-phone, tablet computer, television, e-reader, and the like. The client system may be configured to access and display the training system 100, as well as accept input from a user. The client system may comprise any suitable computing device, for example a special-purpose computer, a general-purpose computer specifically programmed to implement or otherwise execute the training system 100, and the like. For example, referring to FIG. 2, the client system 200 may comprise a central processing unit (“CPU”) 210, a memory device 220, a display 230, and an input device 240. The training system 100 may be stored in the memory device 220, while the CPU 210 may be configured to access (read and/or write) the memory device 220, for example via a communicative coupling and/or a data link. The execution of the training system 100 may be performed by the CPU 210. The CPU 210 may also be configured to provide the display 230 with content from the training system 100 and to receive input from the input device 240. In one embodiment, the input device 240 may be integrated into the display 230, such as in a touch screen display. The input device 240 may comprise any suitable system for receiving input from a user (human or otherwise).

In another embodiment, the client system 200 may further comprise a network adaptor 250 that allows the CPU 210 to connect to a remote server 260. The server 260 may comprise a conventional computer server comprising a CPU 210, memory device 220, and network adaptor 250. Thus, the training material may be stored on the server 260 in a user accessible memory device 220 regardless of the memory being located on the client system 200 or on the server 260.

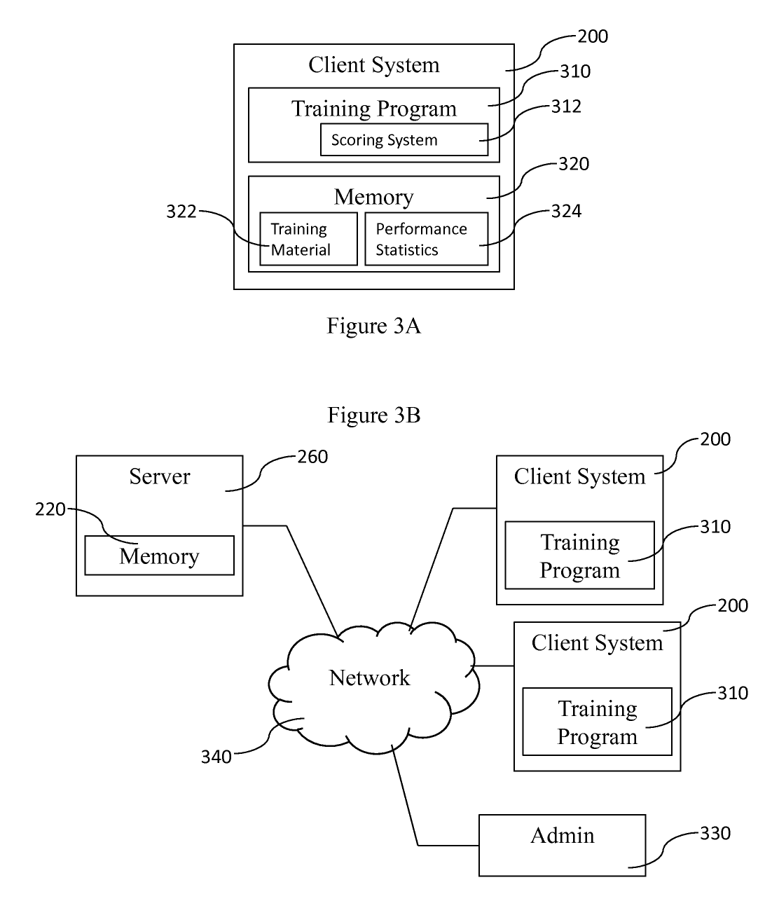

The training system 100 may be divided into separate operating components. For example, referring to FIG. 3A, in one embodiment, the client system 200 may run a training program 310 and operate a memory 320 that contains the training material 322. In one embodiment, the memory 320 may comprise a database. Referring now to FIG. 3B, in another embodiment, the memory 320 may be located on the server 260. The server 260 may be accessible via a network 340. The server may be accessed on a local intranet or accessed over the internet. The training program 310 and the memory 320 may be configured to work seamlessly over the network 340. The network 340 may utilize any suitable method of connection such as a direct network connection, local intranet connection, wireless network connection, internet connection, and the like. An administrator 330 may also be connected to the network 340 and able to connect to the client system 200 and server 260.

The training system 100 may also be configured to keep track of the user's progression through the training system 100 and user performance statistics 324 using a scoring system 312. The scoring system 312 may operate within the training program 310 and modify the performance statistics 324 as the user progresses through the training material 322. The performance statistics 324 may be stored in the memory 320. The training program 310 may update the scoring system 312 based on whether a selected answer was correct or incorrect. The performance statistics 324 may comprise the number of questions the user has answered, the number of questions correctly answered, the amount of time spent using the training system 100, the amount of time spent in each section, the number of times the certify section 130 was attempted, and any other relevant statistics. The performance statistics 324 and the user's progression through the training material 322 may be accessed by the user, an administrator, or any appropriate third party.

Referring to FIG. 3C, the training system 100 may be configured to run on the server 260 and be accessed by and communicate with the client system 200 via an application 350. In one embodiment, the application 350 may comprise an internet browser such as Internet Explorer, Safari, Firefox, Opera, or Chrome etc. In another embodiment, the application 350 may comprise a client system specific application. For example, the application may comprise a native OS application designed to run natively on an operating system such as iOS, Android, Windows, Windows Phone, Symbian OS, Blackberry OS, webOS, Mac OS, Linux, Unix, or any other operating system. The application 350 may also be a cross platform application, such as a Java or Adobe Flash application. The application 350 may display the various elements of the training system 100 and accept user inputs, while training system 100 is operating remotely on the server 260. Thus, the server 260 may receive the user inputs and supply the application 350 with the corresponding information to be displayed.

User input for selecting an answer option or accessing a program menu may be allowed in any manner facilitated by the device that is being used. For example, on a personal computer, the training program 310 may be designed to accept both keyboard and mouse input. In another example, on a touchscreen device such as a tablet computer or smartphone, the training program may be configured to receive a touchscreen input.

The training system 100 may be installed on one or more client systems. For example, if the training system 100 operates solely on the client system 200, then the training system 100 may be installed in a manner similar to a conventional computer program or hardcoded into the machine. If the training system 100 is implemented across multiple computers, such as with the client system 200 and the server 260, then relevant elements of the training system 100 may be installed on the server 260. Additional elements may be implemented by the client system 200, or the client system 200 may operate merely as a terminal, for example if the client system 200 is utilizing an internet browser to interface with the training system 100 that is operating on the server 260. If the application 350 comprises a native OS application, then the native OS application may be installed on the client system 200.

The user may begin training by starting the read section 110. The read section 110 may comprise bulk material for consumption by the user. The training system 100 may require that the read section is presented to the user before the apply 120 section can be accessed. The bulk material may comprise material designed to convey the training material 322 to the user and may include rules, guidelines, essays, reports, charts graphs, diagrams, or any other means of conveying the training material 322. The read section 110 may also be available at any time for the user to use as reference material.

For example, the read section 110 may include information relating to a new sales protocol. In this example, the read section 110 may comprise an outline of the sales protocol itself, instructions on situations where the sales protocol should be used, diagrams conveying the effectiveness of the sales protocol in those situations, information relating to how to identify a situation where the sales protocol should be used, and the like. The read section 110 may also provide a user with a lecture with the information, and/or may include video of the sales protocol being used. In other words, the read section 110 may provide the user with the training material 322, but may not actively require the user to apply the training material 322.

The apply section 120 may simulate situations that require the application of the training material 322. The training material 322 may comprise testing content. The apply section 120 may be configured as a case study based teaching and assessment system comprising testing content and a scoring system 312. The testing content may comprise multiple case studies, questions based on the cases studies, potential answers to the questions, and explanations of the best answers for each question. In addition, each potential answer and answer explanation may correspond to a particular skill presented or otherwise developed by the training material, each skill may be associated with an icon, and the training material 322 and/or testing content may comprise one or more icons. The scoring system 312 may track any relevant performance statistics 324, such as the user's correct and incorrect responses, progression through the testing content and/or training material 322, one or more floor scores (described below), a game score (described below), one or more habit scores (described below), and the like.

The testing content may comprise any suitable content for teaching, for example promoting and assessing learning of, the training material 322. The testing content may be configured in any suitable format. For example, the testing content may comprise the case study, the question prompt, potential answers, answer explanations, and icons associated with the skills corresponding to the answer explanations. The case study may provide a series of facts and or situations that are directed towards simulating situations and complex problems that the user will potentially encounter in the future, causing the user to simulate the decision making required in those situations. The question prompt may then ask a question or ask for a best course of action for the given situation or facts. The potential answers may be displayed and may include a series of possible courses of action or responses, and icons associated therewith. Depending on the answer selected, an answer explanation and/or an associated icon may be displayed and a score may be determined and recorded to the performance statistics 324. The user may then move on to the next case study. The testing content may comprise a series of case studies each having the same set of potential answers, also known as an R-type question. Therefore, an R-type question may be considered a series of multiple choice questions.

A case study may comprise fact patterns, statements, quotes, conversations, events, decisions, projects, policies, and/or rules that may be analyzed by the user to determine a correct response or course of action. The case study may offer enough information to perform an in-depth examination of a single event or case. The case study may comprise information that is relevant to the training material 322 and may include field-of-study related situations. Thus, the case studies may be configured to provide the user with repeated exposure to relevant situations for the user to learn the training material 322 and/or develop relevant skills. The case study may comprise text, video, a picture, any other media or combination of media, and the like. Similarly, the question prompt, potential answers, and/or answer explanation may comprise text, video, a picture, any other media or combination of media, and the like.

The question prompt may be any relevant question with regard to the case study. In one embodiment, the question prompt may be configured to simulate a real world decision making process. For example, the question prompt may ask a user for the most appropriate response to a query from a customer, the question prompt may ask the user to pick an option that best describes the situation, the question prompt may ask the user to pick a best course of action, and the like. More specifically, the testing content may comprise a multiple choice question comprising a case study and potential answers, and the question prompt may comprise any indication that the user should pick the one or more best potential answers. In one embodiment, the question prompt may not be presented with each individual case study, but may instead occur before the case studies are presented, in a set of instructions, and the like.

The potential answers may comprise a plurality of multiple choice answers that may or may not be relevant to the question prompt and/or fact pattern. The potential answers may be located in any suitable location relative to the question prompt. The potential answers may each be user selectable and de-selectable. A potential answer may comprise text and/or one or more icons. In the embodiments wherein a potential answer comprises text and an icon, the icon may be located in any suitable location relative to the text.

The testing content may comprise answer explanations for each potential answer and may be used to convey the training material 322. The user may select an answer to a proposed question regarding a case study and the apply section 120 may provide the user feedback regarding whether the selected answer was correct or incorrect and why an answer is a best answer. The feedback may comprise text and/or one or more icons.

The testing content may be supplied by any suitable source. For example, the testing content may be generated by a third party from training material 322 supplied by a user, administrator, and/or a by the third party. In another embodiment, the testing content may be modified by the administrator. The training material 322 comprises the testing content.

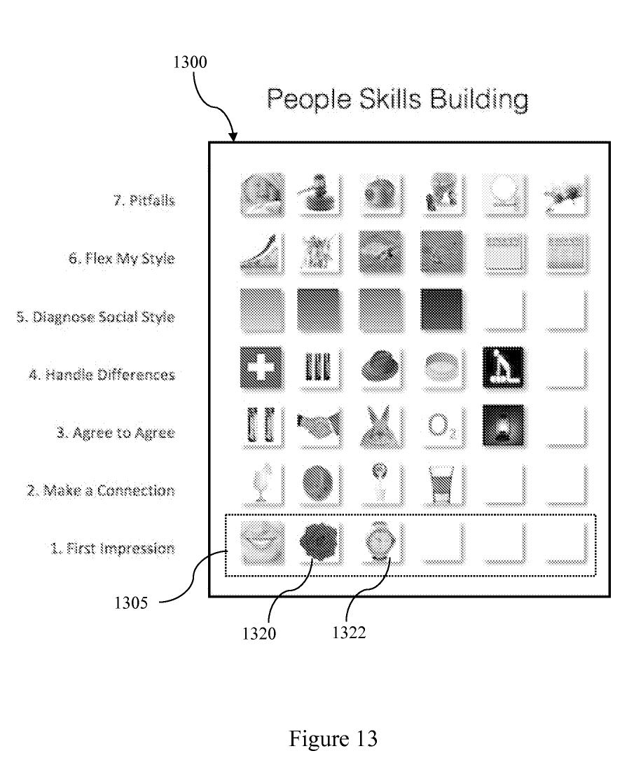

The testing content may comprise one or more pools of multiple choice questions (“MCQs”). The one or more pools of MCQs may be created in any suitable manner. In one embodiment, a job that a user is to be trained for by the training system 100 may require one or more skills. The one or more skills may be identified and organized into one or more hierarchies. For example, referring now to FIG. 13, a job may comprise a pharmaceutical sales position. Some of the skills required for the job may comprise people skills. The hierarchy of people skills may be represented by a skill building 1300 (e.g. labeled “People Skills Building”) comprising one or more floors 1305 (e.g. labeled “First Impression,” “Make a Connection,” and so on), wherein each floor comprises one or more skills. The one or more skills may be represented by one or more icons 1320, 1322. Icons are described in further detail below.

The skills may be assigned to each floor 1305 based on one or more suitable criteria. As a first exemplary criterion, the skills assigned to the lowest floor 1305 may be the skills that are used most often for the job and/or are most vital for the job. For example, the rose icon 1320 may represent the skill of smiling and using a person's name, and if this skill is not used, several of the other people skills may be undermined. As a second exemplary criterion, the skills assigned to the lower floors 1305 may be required before a person can learn or properly use a skill assigned to a higher floor 1305. For example, the skills on the floor 1305 labeled “Diagnose Social Style” may be placed on a lower floor 1305 than the skills on the floor 1305 labeled “Flex My Style,” because if the user cannot diagnose the social style of the customer, it may not matter how well the user can flex their own style.

Once the skills for a hierarchy have been identified and assigned to a floor 1305, MCQs relating to the skills in the hierarchy may be created by the administrator, by any suitable third party, and/or by any suitable system or method. In one embodiment, a skill hierarchy comprises approximately twenty (20) to forty (40) skills, and approximately 600 MCQs may be created for the skill hierarchy.

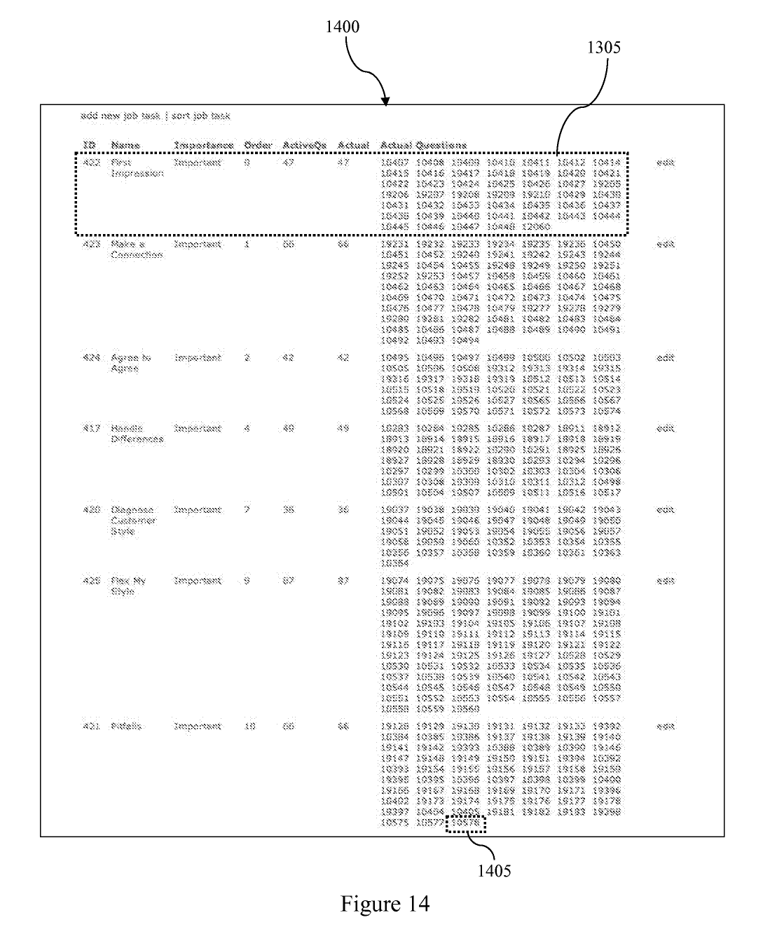

A floor pool of MCQ (“floor pool”) may comprise the MCQs created for a particular floor 1305 in the hierarchy. A course pool of MCQ (“course pool”) may comprise the floor pool for each floor in the hierarchy, and a training course may comprise the course pool. For example, referring to FIG. 14, in one embodiment the MCQs for a hierarchy may be suitably stored in one or more databases 1400. Each MCQ may be assigned a database number 1405, and each database number 1405 may be organized by the database 1400 according to the floor 1305 for which the MCQ was created or otherwise assigned.

In one embodiment, the apply section 120 may present the user with a case study to evaluate. In addition to the case study, the apply section 120 may also present the user with a question prompt and potential answers. A potential answer may comprise text and/or one or more associated icons. Each of the potential answers may be selectable. In the embodiments wherein a potential answer comprises text and an icon, the text and/or the icon may be selectable. The apply section 120 may also present the user with an answer confirmation button to confirm that a selected answer is the user's final answer.

The confirmation button may be configured to allow the user to confirm that the selected answer and/or icon is the user's answer and that the user is ready to move on. Once the confirmation button is selected, the user's answer selection may be graded and scored and the feedback may be displayed. In an alternative embodiment, the user's answer selection may be graded and scored and feedback may be displayed upon the user selecting a potential answer, without the user having to confirm the answer selection.

The user may select a potential answer from the list of potential answers and then select the answer confirmation button to confirm the selection and move forward. The apply section 120 may then evaluate the selection to determine if the best or correct answer was selected. The apply section 120 may then notify the user whether the correct answer was selected and offer an explanation as to why the answer is correct. The apply section 120 may also provide the user with an explanation as to why an incorrect answer is either incorrect or not the best answer. The apply section 120 may present an icon associated with a skill discussed by the explanation. The case study, question prompt, potential answers, answer explanation, and/or icon may be provided by an MCQ from the course pool.

The apply section 120 may also present the user with an advance button that the user may use to indicate that they are ready to move on to the next problem. As each case study is evaluated and answered, the training system 100 may keep track of performance statistics 324. As described above, the performance statistics 324 may comprise any relevant performance statistics 324 including, the number of questions attempted, the number of questions answered correctly, the amount of time spent on each question, one or more floor scores (described below), a game score (described below), one or more habit scores (described below), any other relevant performance information, and/or any other relevant information corresponding to a user's progress through the training material.

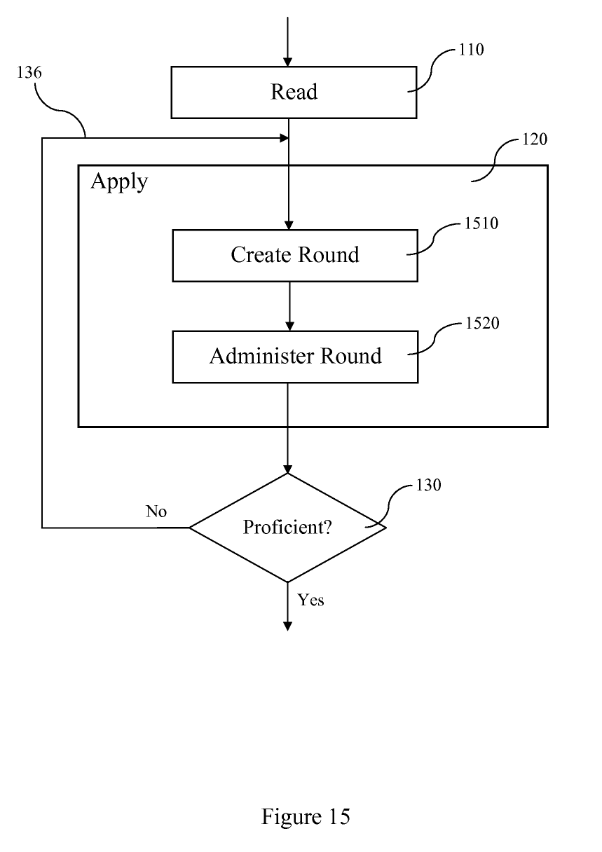

Referring now to FIG. 15, the apply section 120 may comprise creating a round of questioning (1510) and administering the round of questioning (1520). Creating a round of questioning (1510) may comprise any suitable system or method for selecting a set of questions from the course pool. Because the course pool comprises one or more floor pools, creating a round of questioning (1510) may comprise selecting a set of questions from one of the course pools. The set may comprise any number of MCQs, for example from one MCQ to all of the MCQs in the course pool and/or floor pool. In one embodiment, a round of questioning may be created (1510) for an individual floor 1305 by selecting one or more MCQs from the floor pool corresponding to the individual floor 1305.

Creating a round of questioning (1510) may comprise selecting a first predetermined number of MCQs from the course pool and/or floor pool. The first predetermined number of MCQs may be represented by the variable “T”. The course pool and/or floor pool may comprise one or more introductory MCQs and one or more non-introductory MCQs, and selecting T MCQs may comprise selecting a second predetermined number of introductory MCQs (represented by the variable “I”) from the course pool or floor pool and T−I (T minus I) non-introductory MCQs from the same pool. The introductory MCQs may be easier than the non-introductory MCQs.

The variables T and I may be used as hard or soft limits for selecting MCQs. For example, if the variable I is set to six (6) and used as a soft limit, and five (5) introductory MCQs from a floor pool have already been selected and the sixth introductory MCQ selected from the floor pool is the first MCQ of an R-type series of four (4) MCQs, then the entire R-type series of four (4) MCQs will be selected such that the total number of introductory MCQs selected is nine (9). If the variable I is used as a hard limit, then the R-type series may be broken up such that only six (6) introductory MCQs are selected, the R-type series may be skipped in favor of a non-R-type MCQ from the floor pool, and the like.

For further example, if the variable T is set to twenty-five (25) and the variable I is set to six (6), then creating a round (1510) may comprise selecting 19 (T−I) non-introductory MCQs from a floor pool. If the variable T is used as a soft limit, and after selecting seventeen (17) non-introductory MCQs the next MCQ selected from the floor pool is an R-type series of five (5) MCQs, the entire R-type series will be selected such that the total number of non-introductory MCQs selected is twenty-two (22). In this manner, the total number of MCQs selected may exceed T if T is used as a soft limit.

Selecting MCQs may be done in any suitable manner. For example, MCQs may be selected by the training system 100 randomly, in order of their storage in the database 1400, according to difficulty, and the like. In one embodiment, MCQs from a pool are selected randomly, except that an R-type series of MCQs are selected as the full series and contain no randomization within the series. In one embodiment, a MCQ cannot be selected a second time from a pool until all MCQs in the same pool have been selected. This facilitates the presentation of each MCQ from the pool before any MCQs from the same pool are repeated.

Selecting MCQs may be performed at any suitable time and in any suitable combination with administering the round of questioning (1520). In one embodiment, all MCQs that will be administered (1520) during the round of questioning may be selected before the step of administering the round of questioning (1520) begins. In one embodiment, each MCQ that will be administered (1520) may be selected and then administered (1520) prior to the selection of the next MCQ to be administered (1520).

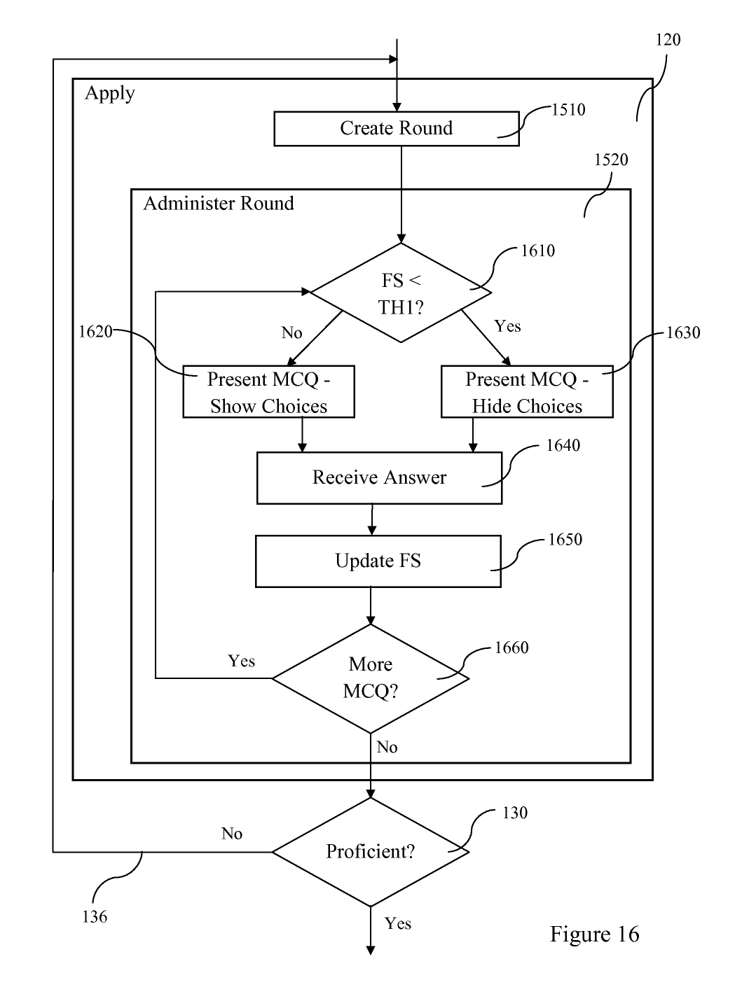

Referring now to FIG. 16, administering a round of questioning (1520) may comprise any suitable system or method for presenting the one or more selected MCQs (1620, 1630) to the user and receiving the user's answer selection (1640) for each presented MCQ. Presenting the one or more MCQs (1620, 1630) may comprise any suitable system or method for presenting the case study and potential answers to the user, and allowing the user to select one or more potential answers. Receiving the user's answer selection (1640) may comprise any suitable system or method for observing, obtaining, or otherwise knowing which one or more potential answers were selected by the user. For example, the user's answer selection may be received (1640) through any suitable input, such as by keyboard, mouse, touch screen, network interface, and the like.

Administering the round of questioning (1520) may further comprise retrieving one or more MCQs prior to the step of presenting the one or more MCQs. The MCQs may be retrieved from any suitable computer storage, such as the database 1400 (referring to FIG. 14), the memory 320 (referring to FIG. 3A), and/or the memory 220 (referring to FIG. 3B). Alternatively, creating a round of questioning (1510) may sufficiently provide the one or more MCQs such that their retrieval is unnecessary. Retrieving one or more MCQs may be done at any suitable time, for example while creating a round of questioning (1510), after creating a round of questioning (1510) but before administering the round of questioning (1520), immediately before each MCQ is presented (1620, 1630), and so on.

Referring again to FIG. 16, administering the round of questioning (1520) may further comprise updating a floor score (“FS”) (1650). The FS provides a measure of the user's proficiency with the MCQs of the floor pool from which MCQs are being administered (1520). Each floor pool may be associated with its own FS, and each FS may be updated independently of the other FSs. The FS may be based on how many MCQs of the floor pool have been answered correctly. For example, the FS may be based on how many of a previous predetermined number of MCQs from the same floor were answered correctly, may be based on the total number of MCQs from the same floor that were answered correctly, may be based on the number of MCQs from the same floor that were answered correctly during the current round of questioning, and the like. Administering a round of questioning (1520) may further comprise, between receiving the answer selection (1640) and updating the FS (1650), a step of determining whether the received answer selection is the correct answer for the MCQ. Determining whether the received answer selection is correct may be done in any appropriate manner, for example by comparing the user's answer selection to the correct answer selection as stored in the database 1400 or otherwise stored in a memory.

In one embodiment, the MCQ may be presented (1620, 1630) for a predetermined amount of time, and if the user does not select a potential answer within the predetermined amount of time, receiving the answer selection (1640) may comprise considering the user answer selection to be incorrect. The predetermined amount of time the MCQ may be presented (1620, 1630) for may be any suitable time for the user to comprehend the case study and select a potential answer. For example, the predetermined amount of time the MCQ may be presented (1620, 1630) may be one (1) to five (5) minutes, and in one embodiment the predetermined amount of time the MCQ may be presented (1620, 1630) is three (3) minutes. The predetermined amount of time may also be configured to prevent a user from dwelling on a question and to provide motivation to continue at an appropriate pace through the MCQs. The predetermined amount of time the MCQ may be presented (1620, 1630) for may be represented by a timer (a “MCQ timer”).

A FS for a floor pool may be initialized before the first round of questioning from the floor pool is presented (1620, 1630). The FS may be initialized in any appropriate manner and to any suitable value. In one embodiment, the FS is initialized to zero (0). In another embodiment, the FS may not need to be explicitly initialized, but may be automatically initialized if the FS is automatically set to some known value upon creation, as is done in some software programming languages. The FS may be initialized and/or updated (1650) by the scoring system 312.

The FS may be based on how well the user has been answering MCQs based on a sliding window of MCQs. In one embodiment, a FS may be updated (1650) using the formula FS=NC/FSW, where FSW (Floor Sliding Window) is the size of the sliding window and is a predetermined number, and where NC is the number of the past FSW MCQs from the associated floor pool that were answered correctly. For example, if FSW is set to thirty (30) and the user has answered fifteen (15) of the last thirty (30) MCQs from the first floor pool correctly, the FS associated with the first floor pool is 15/30=0.5 (or 50%). For further example, if FSW is set to thirty (30) but only twenty (20) MCQ from the first floor pool have been presented and only twelve (12) of those were answered correctly, then the FS associated with the first floor pool is 12/30=0.4 (or 40%).

The FS may be based on a percentage of MCQs asked and/or answered correctly. In one embodiment, the FS may be updated (1650) by calculating the percentage of the MCQs for the current floor that have been answered correctly. For example, if 100 MCQs have been presented for the current floor (during one or more rounds of questioning), and the user has answered 55 of those MCQs correctly, then the FS is 55%. In another embodiment, the FS may be updated (1650) by calculating the percentage of MCQs that have been answered correctly during the current round of questioning. For example, if a round of questioning comprises 30 MCQs and the user has answered 15 of the MCQs correctly so far, then the FS is 50%.

The FS may be updated (1650) at any appropriate time. In one embodiment, the FS is updated (1650) after receiving each answer selection (1640). In another embodiment, the FS is updated (1650) after receiving the answer selections (1640) for all of the MCQs presented (1620, 1630) in the round of questioning. In one embodiment, because the introductory MCQs may be easier than the non-introductory MCQs, a predetermined number of introductory MCQs may be counted when updating the FS (1650), and any introductory MCQ administered (1520) after the predetermined number of introductory MCQs has been administered (1520) may not be counted when updating the FS (1650). For example, the introductory MCQs administered (1520) in the first round of questioning for a floor pool may affect the associated FS, but introductory MCQs administered (1520) in subsequent rounds of questioning for the floor pool may not affect the associated FS. In one embodiment, the introductory MCQs may be administered before the non-introductory MCQs. The user, administrator, or any suitable third party may choose if and/or how many introductory MCQs will be administered per floor pool and/or per course pool.

The FS may be checked (1610) to determine whether or not the potential answers will be initially shown or hidden when the case study is presented. In one embodiment, the case study and potential answers of a MCQ may be presented to the user at the same time or approximately the same time (1620) if the FS is below a first threshold (“TH1”), and the case study of a MCQ may be presented to the user but the potential answers hidden (1630) if the FS is greater than or equal to the TH1. Showing the potential answers with the case study (1620) may be referred to as a “skills filter,” and initially hiding the potential answers (1630) may be referred to as an “icon-uncover filter” or a “habit filter.” This allow the user an opportunity to review the case study and potential answers if their FS is below TH1, but increases difficulty if the FS is above TH1 by requiring the user to know the correct answer ahead of time. In one embodiment, TH1 is 60%. Hiding the potential answers may be performed by any suitable system or method for making the potential answers unobservable by the user, for example visually covering the potential answers, not transmitting the potential answers to the device, displaying the potential answers on a separate screen, and the like. Showing the potential answers may be performed by any suitable system or method for making the potential answers observable by the user.

For example, if the FS is above TH1, the user has an opportunity to review the case study but is prevented from using testing techniques, such as cueing and answer elimination, to increase the odds of answering the MCQ correctly. In the case that the potential answers are initially hidden (1630), the user may indicate that the potential answers should be presented so that the user can answer the MCQ. In one embodiment, upon indication that the potential answers should be shown, the potential answers are shown for a short predetermined period of time and if the user does not select a potential answer within the short predetermined amount of time, receiving the answer selection (1640) may comprise considering the user answer selection to be incorrect. The short predetermined period of time may comprise any time period suitable for allowing a user to observe the potential answers but not long enough to allow a user to dwell on the potential answers or otherwise use testing techniques to increase the odds of the choosing the correct answer. For example, the short predetermined period of time may be two (2) to ten (10) seconds, and in one embodiment the short predetermined period of time is four (4) seconds. Requiring an answer in a short period of time requires the user to have formulated the correct answer before indicating that the potential answers should be shown. The short predetermined period of time may be represented by a timer (an “option timer”). In one embodiment, the user, administrator, or any suitable third-party may manually turn on and/or off the skills filter and/or icon-uncover filter.

Referring again to FIG. 16, administering the round of questioning (1520) may further comprise checking (1660) if there are any more MCQs to be presented (1620, 1630) in the round of questioning. If the check for additional MCQs (1660) is positive, then the check (1610) for whether the potential answers should be shown (1620) or hidden (1630) may be performed and the next MCQ from the round of questioning may be presented. If the check for additional MCQs (1660) is negative, then a check for whether the user has demonstrated proficiency (130) may be performed.

Determining whether a user is proficient (130) may comprise any suitable determination of the user's ability with the skills associated with the course pool of MCQ. In one embodiment, a user may be deemed proficient (130) if the user has obtained a FS greater than or equal to a second predetermined threshold (“TH2”) for each FS associated with the course pool of MCQ. In one embodiment, TH2 is 80%. If the user is proficient, the apply section 120 may be considered complete. Briefly referring to FIG. 1, if the apply section 120 is complete, the training of the user for the training course may be complete 140 and may be ended.

If the user is not proficient, another round of questioning may be created (1510). The additional round of questioning may be created (1510) from a floor pool for which the user has not obtained a FS greater than or equal to TH2. Therefore, in one embodiment, once a user has obtained a FS greater than or equal to TH2, the user will no longer be presented with MCQ from the associated floor pool. In one embodiment, the user may choose when to start the next round of questioning. In another embodiment, the next round of questioning may occur at a predetermined time or may occur immediately. In one embodiment, the determination of whether a user is proficient (130) may occur before the check for additional MCQs (1660). A game score for a training course may be calculated as the average of each of the floor scores associated with the course pool.

In one embodiment, the apply section 120 may comprise updating one or more habit scores (“HS”). Each HS may be associated with a skill in the skill hierarchy associated with a course pool of MCQs. Each HS may provide a measure of how well the user is applying the associated skill. A HS for a particular skill may be based on how well the user has been answering the MCQs having a correct answer associated with the particular skill, and may be independent of which floor pool the MCQ came from. For example, the HS for a particular skill may be based on how many MCQs having a correct answer associated with the particular skill have been answered correctly, regardless of which floor pool the MCQ came from. If a MCQ has multiple potential answers that must be selected for the question to be answered correctly, each potential answer may be associated with a separate skill, and therefore multiple HSs may be updated when a MCQ is answered.

The HS may be based on a percentage of MCQs having a correct answer associated with the particular that have been asked and/or answered correctly. In one embodiment, the HS may be updated by calculating the percentage of the MCQs having a correct answer associated with the particular skill that have been answered correctly. For example, if 100 MCQs having a correct answer associated with a skill called “Greeting” have been presented, and the user has answered 55 of those MCQs correctly, then the HS associated with the “Greeting” skill is 55%.

The HS may be based on a sliding window of MCQs. In one embodiment, a HS for a particular skill may be updated using the formula HS=NHC/HSW, where HSW (Habit Sliding Window) is the size of the sliding window and is a predetermined number, and where NHC is the number of the past HSW MCQs having a correct answer associated with the particular skill that were answered correctly. For example, for a skill called “Greeting”, if HSW is set to thirty (30) and the user has correctly answered fifteen (15) of the last thirty (30) MCQs having the skill “Greeting” as a correct answer, the HS associated with the skill “Greeting” is 15/30=0.5 (or 50%). For further example, if HSW is set to thirty (30) but only twenty (20) MCQs having the skill “Greeting” as a correct answer have been presented (1620, 1630) and only twelve (12) of those were answered correctly, then the HS associated with the skill “Greeting” is 12/30=0.4 (or 40%).

The HS may be updated at any appropriate time. In one embodiment, the HS is updated after receiving each answer selection (1640). In another embodiment, the HS is updated after updating the FS (1650). In yet another embodiment, the HS is updated after receiving the answer selections (1640) for all of the MCQs presented (1620, 1630) in a round of questioning.

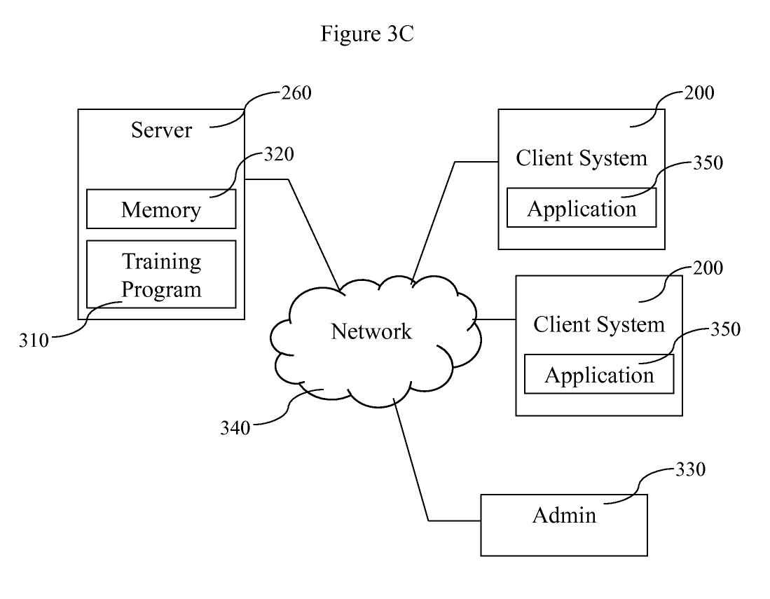

Referring to FIG. 4, in one embodiment, presenting the one or more MCQs (1620, 1630) and/or receiving the answer selection (1640) may be accomplished by a testing window 400. Additional steps of administering a round of questioning (1520) may also be performed by the testing window 400, such as hiding and showing the potential answers, and allowing the user to indicate that potential answer should be shown.

A testing window 400 may run on a client system 200 and be configured to display a case study window 410, an explanation window 420, and a menu 430. The case study window 410 may be configured to display a relevant case study 411, a question prompt 412 regarding the case study 411, potential answers 413, 414, 415, 416, and a confirmation button 417. A potential answer may comprise an associated icon. Any number of potential answers may be displayed. Once one of the potential answers 413, 414, 415, 416 has been selected, the confirmation button 417 may be selected, and the explanation window 420 may be activated to reveal an answer indicator 421 and an explanation 422. The explanation window 420 may comprise an icon associated with the explanation 422. In one embodiment, the explanation window 420 may also include alternative explanations 423, 424, 425 that may be selected to provide reasoning as to why each of the incorrect multiple choice answers are not the best answer. The menu 430 may be configured as a drop-down menu.

The case study window 410 may be configured to display the case study 411, the question prompt 412, the multiple choice answers 413, 414, 415, 416, and the confirmation button 417. The case study window 410 may be arranged in any suitable way to facilitate displaying the case study 411 and the multiple choice answers 413, 414, 415, 416. For example, the case study window 410 may be arranged with the question prompt 412 displayed at the top of the case study window 410, the multiple choice answers 413, 414, 415, 416 in the middle of the case study window 410, and the case study 411 at the bottom of the case study window 410. The case study window 410 may be arranged differently for different case studies 411.

The explanation window 420 may be configured to appear after the user has selected one or more of the multiple choice answers 413, 414, 415, 416 and has confirmed that selection using the confirmation button 417. The explanation window 420 may display whether the user selected the correct answer using the answer indicator 421. The explanation window 420 may comprise an explanation 422 describing the correct answer for the case study. The explanation window 420 may comprise an icon associated with the explanation. In one embodiment, the explanation window 420 may include alternative explanations 423, 424, 425 that may be selected. The alternative explanation 423, 424, 425 may explain why the corresponding incorrect answers were incorrect. In an alternative embodiment, the explanation window 420 may be configured to appear after the user has selected one of the multiple choice answers 413, 414, 415, 416 without the user having to confirm the selection.

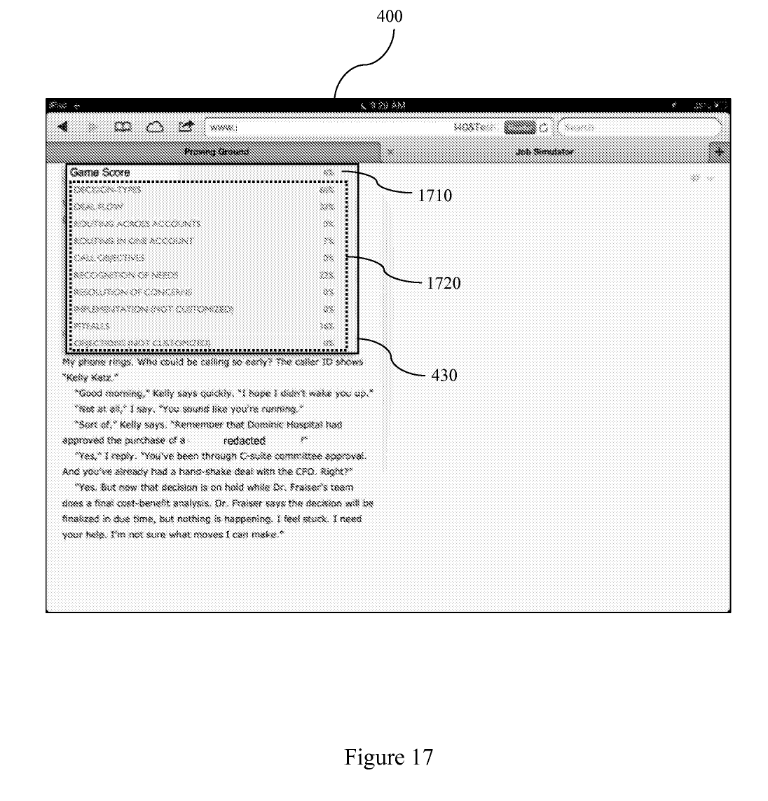

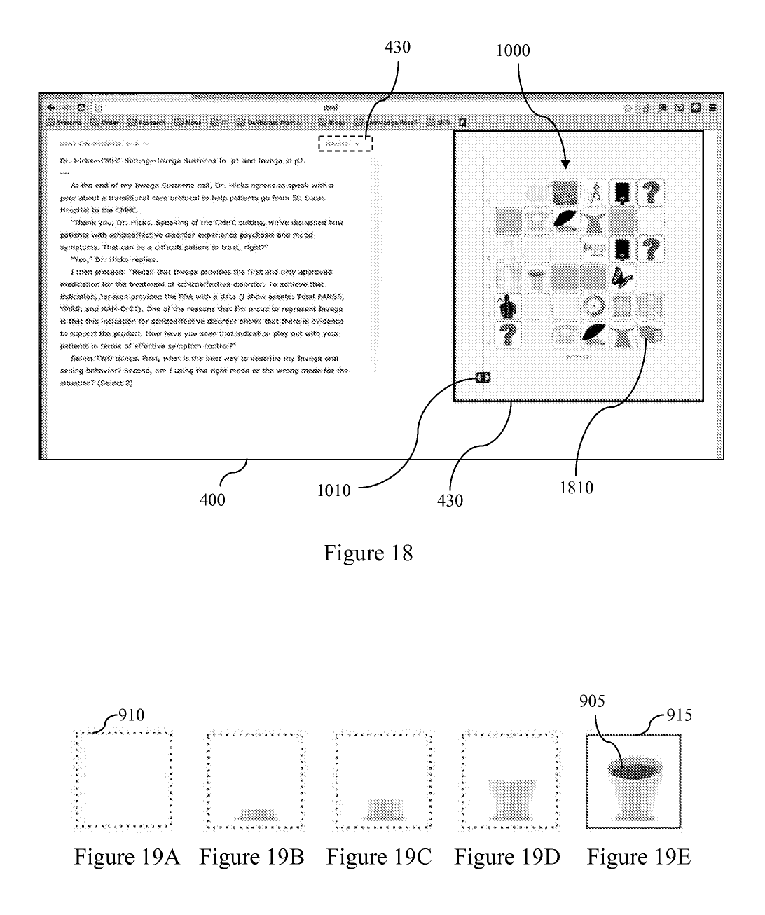

The menu 430 may be positioned at the top of the testing window 100. The menu 430 may be configured to display performance statistics 324 or otherwise cause performance statistics 324 to be displayed. The performance statistics 324 may be broken down into scoring information for various types of testing content. The performance statistics 324 may be based on any relevant scoring factors for the given testing content. For example, the performance statistics 324 may include raw scores, time spent, percentage of correct answers, percentage of questions answered, time remaining, progress through testing content and/or training material 322, or any other relevant scoring information. The scoring information may be broken down between various subjects, topics, training courses, or any other relevant grouping. The scoring factors may include correct answers, time spent on a case study, or any other scoring factor that is suitable for the testing content. Referring to FIG. 17, in one embodiment, the menu 430 may display the game score 1710 and/or one or more floor scores 1720. Referring to FIG. 18, in one embodiment, a menu 430 may cause the display of one or more habit scores and/or a representation 1810 of one or more habit scores (described below).

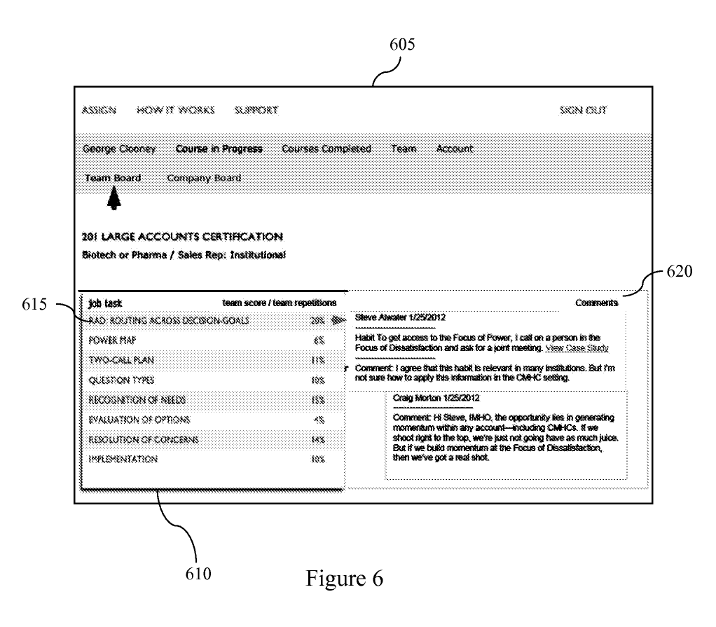

Referring to FIGS. 7A and 7B, an icon 702, 704, 706, 708, 710 may comprise any suitable representation of a skill to be developed by the training material 322. For example, the icon may comprise a picture, sound, animation, video, and the like. The icon may facilitate a user's understanding or recognition of the associated skill. The icon may help increase the speed at which a user understands an explanation and/or recognizes when to apply a certain skill, such as when the user can quickly view and understand one or more icons instead of reading a written explanation or the text of a potential answer. By increasing speed, the user may review more case studies in a given period of time and may be able to identify which potential answer is correct more quickly. By increasing the number of case studies analyzed by the user, content retention and/or proficiency applying the related skill may be increased. By increasing the speed at which a user can identify the correct potential answer, a short amount of time may be provided for the user to select the correct answer such that the user must identify the correct answer ahead of time, because the user will not have sufficient time to eliminate incorrect answers and the effects of cueing will be reduced.

The icons may be activated or deactivated in any suitable manner for the device that the training system is operating on, and may be configured to be controlled by the administrator, user, and or other relevant personnel. In one embodiment, the icons may be enabled or disabled solely by an administrator. In another embodiment, the administrator may elect to enable or disable the icons, or the user may be permitted to enable or disable the icons. When icons are activated or deactivated, the training system 100 may automatically adjust the presentation of the testing content and/or training material 322 accordingly.

Referring again to FIGS. 7A and 7B, in some embodiments, multiple icons 702, 704, 706, 708, 710 may be utilized. One or more of the icons 702, 704, 706, 708 may be placed in the case study window 410, and one or more of the icons 710 may be placed in the explanation window 420. The one or more icons 710 in the explanation window 420 may be hidden until the answer indicator 421 and the explanation 422 are shown. The one or more icons 710 in the explanation window 420 may be utilized to convey a skill that is required to be applied to answer the question prompt 412 correctly. The one or more icons 710 in the explanation window 420 may correspond to at least one of the icons 702, 704, 706, 708 in the case study window 410. For example, one or more of the icons 706 in the case study window 410 may identify a skill that should be applied to arrive at the correct answer, and one or more of the icons 702, 704, 708 in the case study window 410 may identify a skill that is not as correct to apply. In some embodiments, the icons may be user selectable. For example, if one of the icons 710 in the explanation window is selected by the user, the portion of the case study 411 that corresponds to the skill associated with the selected icon 710 may become highlighted. The various icons may be presented in any suitable manner, and an icon may be placed at any suitable location in the testing window 400.

The testing window 400 may comprise a skills filter and/or an icon-uncover filter. The icon-uncover filter may be referred to as a cover-up filter or a habit filter. As described above, the icon-uncover filter may be configured so that the user cannot view the list of potential answers to look for clues for the correct answer. The icon-uncover filter may modify the presentation of the testing content by preventing the list of potential answers from being displayed until after a trigger has been activated. The trigger allows the user to indicate that the potential answers should be presented so that the user can answer the MCQ. The trigger may be any suitable trigger and may be configured to encourage the user to read the complete case study and to formulate an answer to the question before seeing the potential answers. By forcing the user to formulate an answer before seeing the potential answers, the difficulty of the question is increased.

In one embodiment, the trigger may comprise a “show answers” button that may be selected by the user. In another embodiment, the trigger may be a timer. In yet another embodiment, the trigger may comprise a show-answers button that is only selectable after the expiration of a timer. The testing window 400 may comprise a MCQ timer and/or an option timer. In one embodiment, the option timer may be shown in or near the trigger. In one embodiment, the MCQ timer may be shown in or near the menu 430.

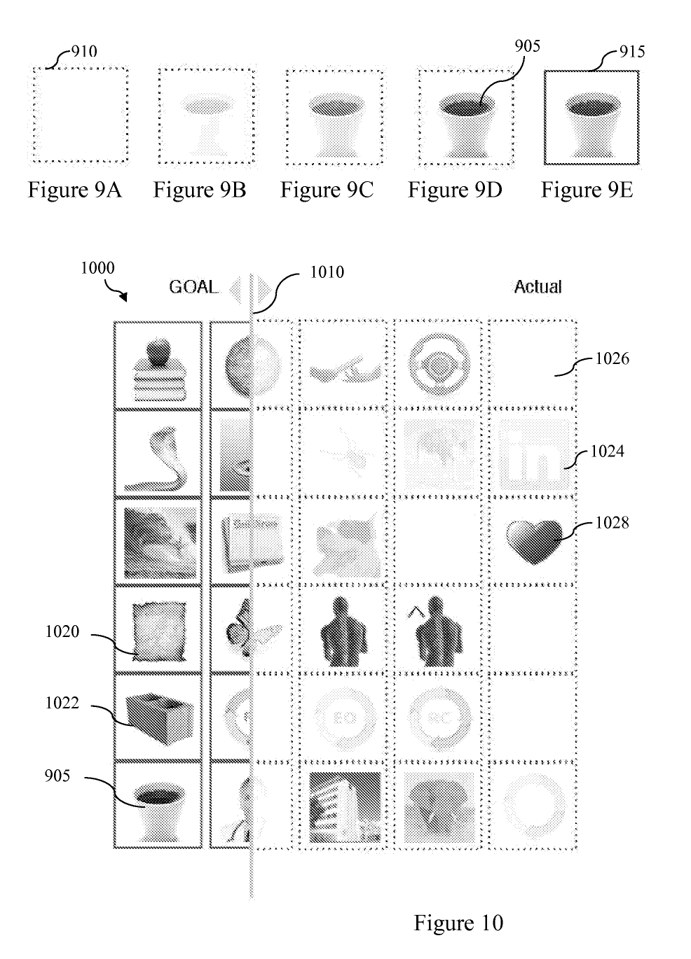

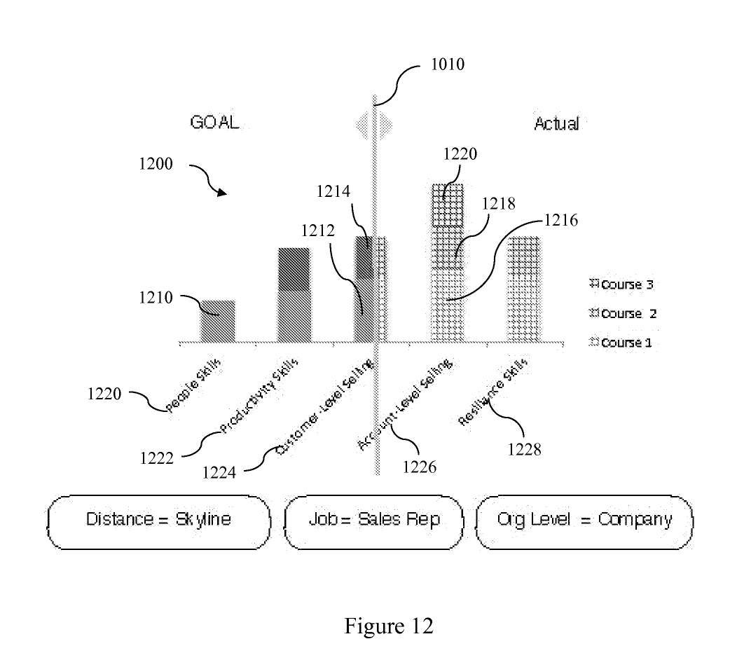

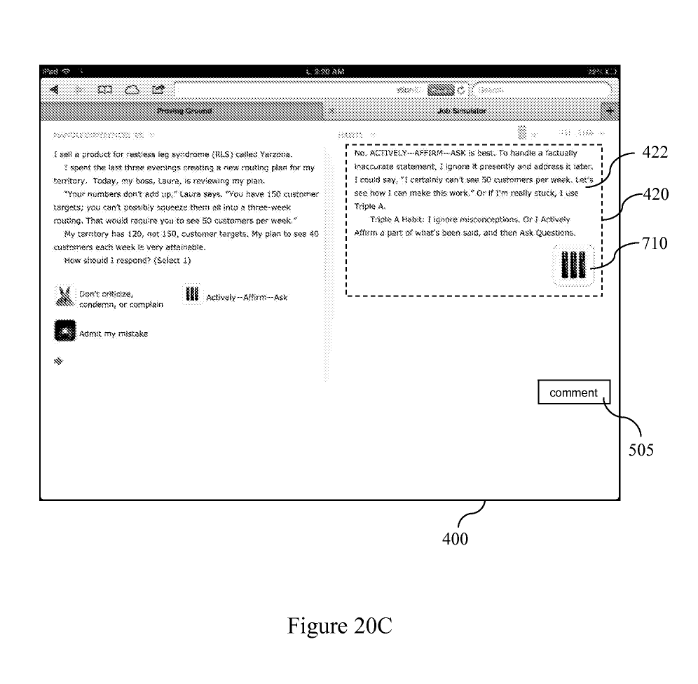

For example, referring now to FIGS. 20A and 4, a testing window 400 may facilitate presentation of a MCQ. In this example, the case study 411 and question prompt 412 for a MCQ are presented, but the potential answers are initially hidden. The testing window 400 comprises a trigger 2010 indicating that the potential answers should be shown. The testing window 400 also may comprise one or more menus 430, for example a menu 430 displaying performance statistics 324, a menu 430 that can be used to display a HS, a menu 430 that can be used to display progress as icons arranged as a group 1000 (referring to FIG. 10) and/or arranged as a skyline 1200 (referring to FIG. 12), a menu displaying the MCQ timer (for example, 3 minutes) and/or a timer representing a maximum allowable practice time per day (for example, 90 minutes), and the like.

Continuing the example, and referring now to FIGS. 20B, 4, and 7, once the trigger 2010 is selected, the potential answers 413, 414, 415 are shown, including their associated icons 702, 704, 706. An option timer 2020 may be shown next to the trigger 2010. The option timer 2020 may count down, and if the user does not answer the MCQ before the countdown is complete (for example, counting down to zero), the MCQ may be scored as incorrectly answered. The user may answer the MCQ by selecting the text and/or icon 702, 704, 706 of a potential answer 413, 414, 415, by selecting any active area associated with a potential answer 413, 414, 415, by clicking a button, by checking a box, and the like. In one embodiment, the user may additionally be required to confirm the answer selection, for example by clicking a confirmation button 417.

After the user has selected a potential answer 413, 414, 415, the training system 100 may receive the user's answer selection. Continuing the example, and referring now to FIGS. 20C, 4, 5, and 7, once the potential answer is selected, an explanation 422 may be displayed along with the icon associated with the correct answer 710. An interactive feature 505 may also be displayed.

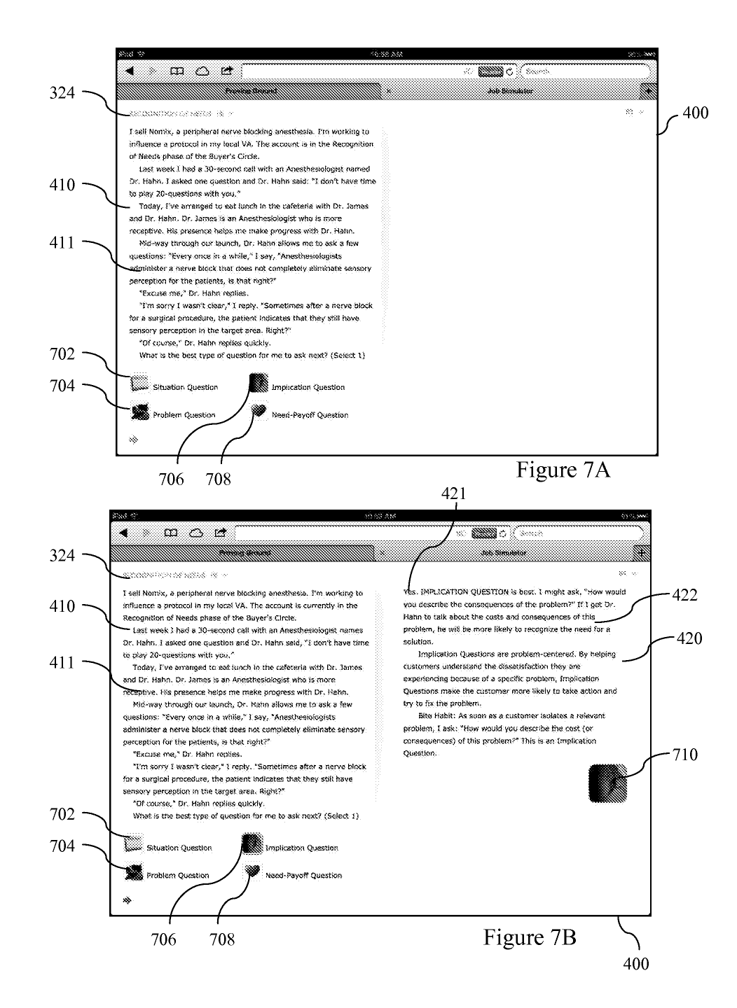

The training system 100 may further comprise a management module configured to allow the monitoring of progress of one or more users through various training programs and or training material 322. For example, referring now to FIG. 8, the management module may be adapted to display a listing of successful practice repetitions for one or more groups, individual users, locations, divisions, and the like. In one embodiment, a successful practice repetition may comprise a single correct answer to a test question. In this manner, the more correct practice repetitions accumulated by an individual or group, the higher the overall score displayed by the management module. The listing of successful practice repetitions may be displayed in any desired manner such as cumulative total of all successful practice repetitions achieved or on a rolling average such as daily, weekly, monthly, quarterly, or any other desired range.

The management module may be further adapted to display the progress or results in an interactive manner that allows for access to more detailed analysis. In one embodiment, each result 802 may comprise an interactive link to a detailed breakdown of the data used to generate the displayed value. For example, the user may be able to select a given result 802, such as one representing the number of successful practice repetitions for a team, and be presented with a detailed breakdown of the successful practice repetitions for each member of the team. Similarly, the user may then select a given team member and receive a detailed breakdown of the successful practice repetitions for that team member.

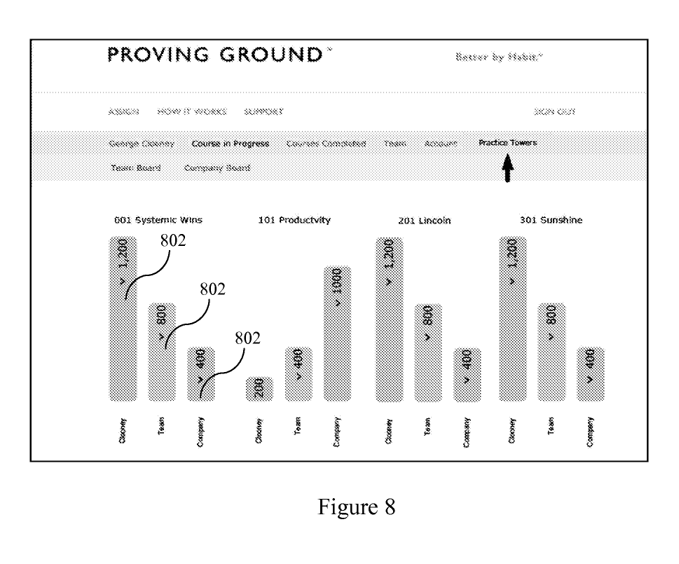

Referring to FIGS. 9A-9E, in an exemplary embodiment, the management module may be adapted to display a representation of progress using one or more icons. An icon may be associated with a skill presented in the training material 322. For example, an icon of a coffee mug 905 may be associated with the skill of writing a task list at the start of a work week.

The display of an icon may be created or altered by the management module to correspond to the progress of the user in correctly applying the associated skill. For example, if a user has never attempted to apply the associated skill, nothing may be displayed. Referring to FIG. 9A, if the user has attempted to apply the associated skill but has not yet applied the associated skill correctly, a dashed outline 910 may be displayed surrounding an area associated with the location of the icon. Referring to FIG. 9B, if the user has applied the associated skill correctly a small percentage of the time, such as 1% to 29%, the icon may be displayed with a low level of opacity, such as 15%. Referring to FIG. 9C, if the user has applied the associated skill correctly a medium percentage of the time, such as 30% to 59%, the icon may be displayed with a medium level of opacity, such as 50%. Referring to FIG. 9D, if the user has applied the associated skill correctly a high percentage of the time, such as 60% to 89%, the icon may be displayed with a high level of opacity, such as 100%. Referring to FIG. 9E, if the user has applied the associated skill correctly almost all of the time, such as more than 90% of the time, the icon may be displayed with a high level of opacity and the dashed outline 910 may be changed to a solid outline 915.

In one embodiment, the display of the icon described above may be created or altered based on how many times the user has attempted to apply the associated skill. For example, if the user has successfully applied the associated skill 100% of the time but has only attempted to apply the associated skill a small number of times, such as fewer than 10 attempts, the display may be altered based on how many times the user has attempted to apply the associated skill. In this example, if the user has successfully applied the associated skill one to three times out of the same number of attempts, the icon may be displayed as shown in FIG. 9B. If the user has successfully applied the associated skill four to six times out of the same number of attempts, the icon may be displayed as shown in FIG. 9C. If the user has successfully applied the associated skill seven to eight times out of the same number of attempts, the icon may be displayed as shown in FIG. 9D. If the user has successfully applied the associated skill nine times out of nine attempts, the icon may be displayed as shown in FIG. 9E. Other representations of progress may be used, such as altering the amount of coffee in the coffee mug icon 905.

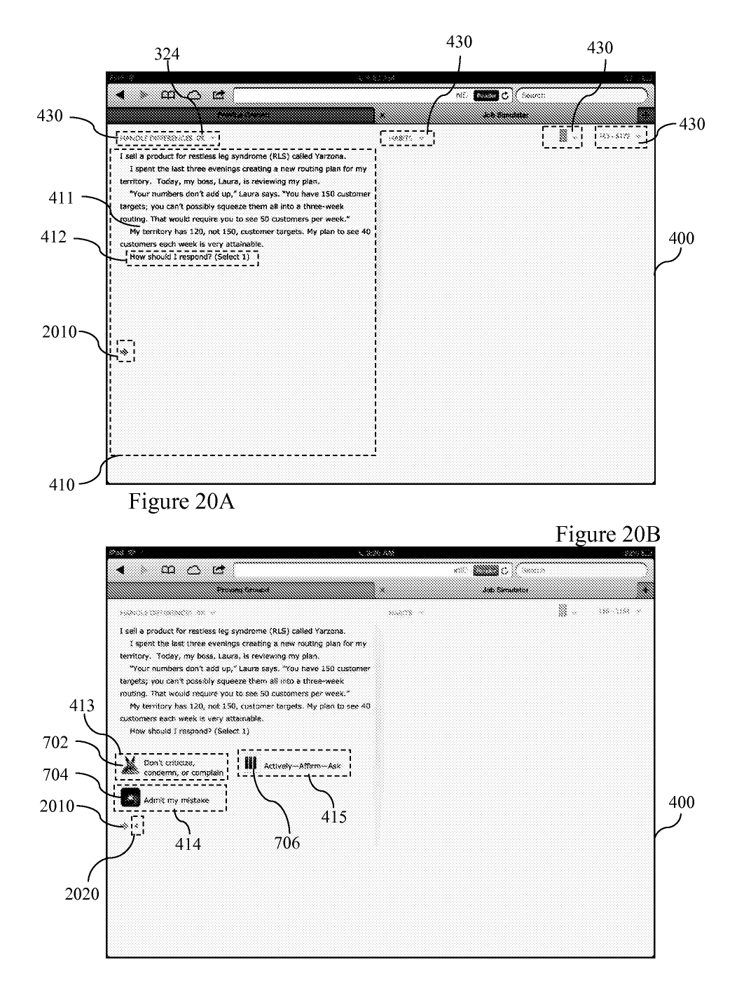

In one embodiment, an icon may be displayed according to the HS associated with the skill the icon represents. The icon may therefore also represent the associated HS. For example, the icon may become more filled in the higher the HS becomes. In an exemplary embodiment, referring to FIGS. 19A-19E, if a HS is 0%, no icon may be shown. Referring to FIG. 19A, if the HS is 19% or less, a dashed outline 910 may be shown. Referring to FIG. 19B, if the HS is 20% to 39%, 20% of the icon 905 may be shown. Referring to FIG. 19C, if the HS is 40% to 59%, 40% of the icon 905 may be shown. Referring to FIG. 19D, if the HS is 60% to 79%, 60% of the icon 905 may be shown. Referring to FIG. 19E, if the HS is greater than or equal to 80%, the entire icon 905 and a solid outline 915 may be shown. In an alternative embodiment, the amount the icon is filled in may be directly proportional to the HS. For example, if the HS is 47%, the icon may be 47% filled in. The display of the icon may be altered in any other suitable manner to represent the HS, for example by changing the opacity of the icon as described with respect to FIG. 9.

Referring to FIG. 10, the management module may be configured to display a group of icons 1000, wherein each icon in the group is associated with a skill to be developed by the training material 322. For example, a particular group of icons 1000 may be associated with the skills to be developed by a particular training course, such as the skills assessed by a course pool of MCQs. Each icon in the group of icons 1000 may be displayed according to the progress of the user in applying the skill associated with the icon. For example, one or more icons 1026 may not be displayed if the user has not successfully applied the associated skill, and one or more icons 1024, 1028 may be displayed with varying levels of opacity based on the progress of the user in applying the associated skill. For further example, the one or more icons may be displayed based on the one or more associated HSs. Referring to FIG. 18, the group of icons 1000 may be shown in the testing window 400, for example by the menu 430.

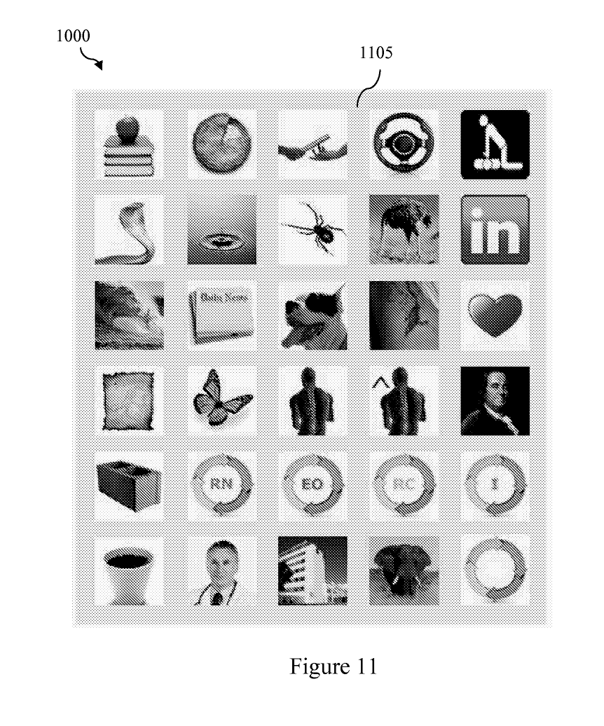

Referring now to FIG. 11, the management module may be configured to create or alter the representation of progress based on a certification. For example, the display of the group of icons 1000 may be altered when a user whom the group of icons 1000 corresponds to is deemed proficient (130) or otherwise completes or passes the particular course. The display may be altered by removing the borders 910, 915 surrounding each icon and placing a colored background 1105 behind the group of icons 1000. Any suitable representation of progress indicating proficiency may be used.

In some embodiments, the display of the group of icons 1000 may be created or altered based on skill degradation. For example, it may be assumed that as the time since completion of a particular training course elapses, the proficiency of the user in applying the skills taught by the training course decreases. The management module may reflect this skill degradation by removing the colored background 1105, adding a solid outline 915 to each icon, adding a dashed outline to each icon 910, and the like, depending on the elapsed time. For example, if six to nine months have passed since completion of the particular training course, the colored background 1105 may be removed and a solid outline 915 may be added to each icon, and if nine to twelve months have passed since completion, the solid outlines 915 may be replaced by dashed outlines 910. For further example, degradation of skill may be represented by adding visual cracks and/or other indicators of deterioration to the group of icons 1000.

In some embodiments, the management module may facilitate the user altering the representation of progress. In an exemplary embodiment, the management module may be configured to provide a sliding bar that a user can move in relation to the representation of progress. For example, referring to FIGS. 10 and 18, a slider bar 1010 may be moved by a user. The group of icons 1000 may be displayed differently on one side of the slider bar 1010 compared to the other side of the slider bar 1010. For example, referring to FIG. 10, the icons 905, 1022, 1020 on the left side of the slider bar may be displayed to represent the desired goal of the particular training material 322 associated with the group of icons 1000, and the icons 1024, 1026, 1028 on the right side of the slider bar may be displayed to represent the actual progress of a user through the training material 322. For further example, if the slider bar 1010 is moved all the way to the right side of the group of icons 1000, one or more icons 1026 that are not yet shown may be displayed. Other methods of altering the display to show actual progress versus goal may be used.

The representation of progress may comprise more than one group of icons 1000. For example, the representation of progress may display the progress of a user through multiple topics, wherein each topic may be taught through multiple training courses. As described, a group of icons 1000 may represent the progress through a training course, and therefore through a particular course pool and skill hierarchy. Consequently, one or more groups of icons 1000 may correspond to the same topic. The management module may arrange the groups of icons 1000 corresponding to the same topic together and apart from groups of icons 1000 corresponding to different topics. The management module may represent degradation of skill independently for each group of icons 1000, or collectively for the one or more groups of icons 1000 corresponding to the same topic.

For example, referring to FIG. 12, the representation of progress may show a user's progress through one or more topics, such as “People Skills” 1220, “Productivity Skills” 1222, “Customer-Level Selling” 1224, “Account-Level Selling” 1226, and “Resiliance Skills” 1228. The topics may be taught by one or more training courses, wherein each training course may be represented by a group of icons 1210, 1212, 1214, 1216, 1218, 1220 (collectively 1200). The management module may arrange one or more groups of icons 1000 corresponding to the same topic in a vertical stack representing a building, and may place the first training course on the bottom of the stack, the second training course above the first, and so on. The management module may arrange the one or more topics to represent a skyline.

For example, referring again to FIG. 12, a topic “Account-Level Selling” may be taught by a total of three training courses. Because each training course is associated with a group of icons 1000, the “Account-Level Selling” topic is associated with three groups of icons 1216, 1218, 1220, and the management module may arrange the three groups of icons 1216, 1218, 1220 together, with the first course on bottom and the third course on top.

The management module may create or change the representation of progress according to one or more user inputs and/or user-selectable options. In an exemplary embodiment, the management module may display the representation of progress based on a job type selectable by a user. A job type may comprise any suitable categorization of a user's function within an organization, such as a sales representative, sales manager, sales director, VP of sales, marketing manager, marketing director, VP of marketing, manager of business operations, director of operations, and the like. For example, the job of a sales representative may comprise the topics “People Skills,” “Productivity Skills,” “Customer-Level Selling,” “Account-Level Selling,” and “Resiliance Skills,” while the job of a manager may comprise more management-related topics. In this embodiment, creating or changing the representation of progress may comprise displaying the topics according to a selected job type.

In an exemplary embodiment, the management module may display the representation of progress based on an organizational level, such as an individual, team, district, region, entire company, and the like. In this embodiment, changing the org level may not cause the management module to change the number of topics displayed or the number of training courses per topic, but may cause the management module to create or alter the display of icons based on the progress for the selected organizational level. For example, a particular user may have been deemed proficient (130) for a particular training course, but the user's team may only be partially complete with the training course. The management module may display a colored background behind the group of icons 1000 corresponding to the course when the organizational level equal to that particular user is selected, but may display lower levels of progress when the organizational level equal to the user's team is selected. The management module may therefore display a representation of progress not just for a single user, but for any organizational level or other grouping of users.

When representing the progress based on an organizational level comprising more than one user, the management module may display the associated icon and/or group of icons 1000 according to a measure of the progress of the more than one user. In one embodiment, the measure of progress of the more than one user may comprise the percentage of the more than one users that have attained a predetermined threshold of progress. For example, if at least 80% of the more than one users have a HS of at least 40% to 59% for a skill, the icon associated with the skill may be displayed as 40% filled in, for example as shown in FIG. 19C. In one embodiment, the measure of progress of the more than one user may comprise a cumulative percentage of the progress of the more than one users. For example, if the more than one users have a combined average HS of 50%, the icon may be displayed as 50% filled in.

In an exemplary embodiment, the management module may display the representation of progress based on a user-selectable view distance. In an exemplary embodiment, a user may select a view distance of the skyline, the topic, course, or skill. For example, if a user selects the view distance of a skill, the management module may display the icon associated with the selected skill. The display of the icon may visually represent a room in a building. If a user selects the view distance of a course, the management module may display a single group of icons 1000 corresponding to the selected course. The group of icons 1000 corresponding to a course may visually suggest a portion of, a set of floors of, or an entire a building.

If a user selects the view distance of a topic, the management module may display the one or more groups of icons 1000 corresponding to the chosen topic. The one or more groups of icons 1000 may visually suggest a building. If a user selects the view distance of the skyline, the management module may display all or a subset of topics, including the groups of icons 1000 corresponding to the displayed topics. Each displayed topic may visually suggest a building, and the one or more buildings may suggest a skyline. The various view distances may be selected in any suitable manner, such as by activating a button, using a pull-down menu, using a pinch-to-zoom operation on a touchscreen device, and the like.

Accordingly, the management module may be configured to represent the progress of a single user or multiple users, at any organizational level, and for any view distance. The management module may facilitate the comprehension of the progress of any desired grouping of users, skills, training courses, topics, job types, organizational levels, and the like.

In some embodiments, one or more of the components of the representation of progress may comprise an interactive link to a detailed breakdown of the data used to generate the displayed value. For example, the user may be able to select a given topic and be presented with the representation of progress for that topic. Similarly, the user may then select a particular group of icons 1000 in the topic and be presented with the representation of progress for the corresponding training course. Similarly, the user may be able to select an icon in a group of icons 100 and be presented with detailed information about the progress for the associated skill for each individual, team, regions, district, division, and the like. For example, if the user is viewing the representation of progress at the organizational level of a team, the user may select the coffee mug icon 905 and may be presented with detailed information regarding the progress of each team member for the associated skill of creating a task list at the beginning of the week.

The training system may further comprise a summary module adapted to present training effectiveness. For example, the summary module may provide analytical results for comparing how well an individual performs their job after completing a given training program or series of training programs. Alternatively, the summary module may be adapted provide results visually in the form of a chart correlating real-world results with successful practice repetitions and/or progress by an individual or group. In one embodiment, the summary module may display a chart correlating an individual's sales results along a first axis against an individual's number of successful practice repetitions and/or progress along a second axis. In another embodiment, the summary module may display a chart correlating an individual's sales results along a first axis against an individual's number of completed training programs and/or progress along a second axis.

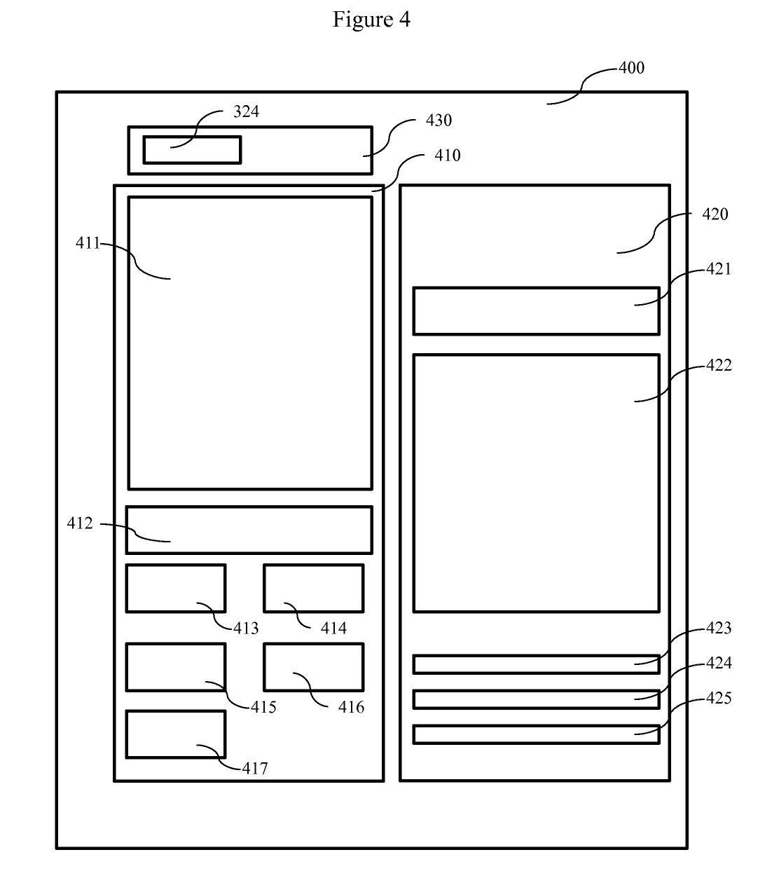

Referring now to FIG. 5, in some embodiments, the testing window 400 may comprise an interactive feature 505 that allows the user to respond to and/or gather additional information concerning a particular question/answer combination relating to a training program. For example, in one embodiment the interactive feature 505 may comprise an interactive comment tool that allows a user to add a comment to a given question and answer combination. The user comment may then be provided to a training center responsible for the training program as a method for improving the training materials. In another embodiment, to facilitate group learning, motivation, and information retention, the user may have the option of directing the comment to a common board for other users to see and/or respond to. The interactive feature 505 may comprise one or more buttons 510, 512, 514 that allow the user to achieve any or all of the above functions, and may comprise an area to enter text 520.

The training system 100 may also be configured to facilitate collaboration among users to improve comprehension and retention of the training material 322 and/or the development of relevant skills. For example, users associated with a given group may have the same training assignment 102 or may be required to progress through the same training material 322, practice skills associated with the training assignment 102 or training material 322, and to demonstrate proficiency with the material covered. Users may be able to utilize the interactive feature 505 to collaboratively discuss test questions, answers to test questions, case studies, simulations, the reasoning why a particular answer is correct, and the like. The interactive feature 505 may encourage discussion and cooperation among the users in the group to facilitate a better overall comprehension of the training material 322 by the group as a whole. The interactive feature may also increase the users' motivation to progress through the assignment 102 or training material 322.

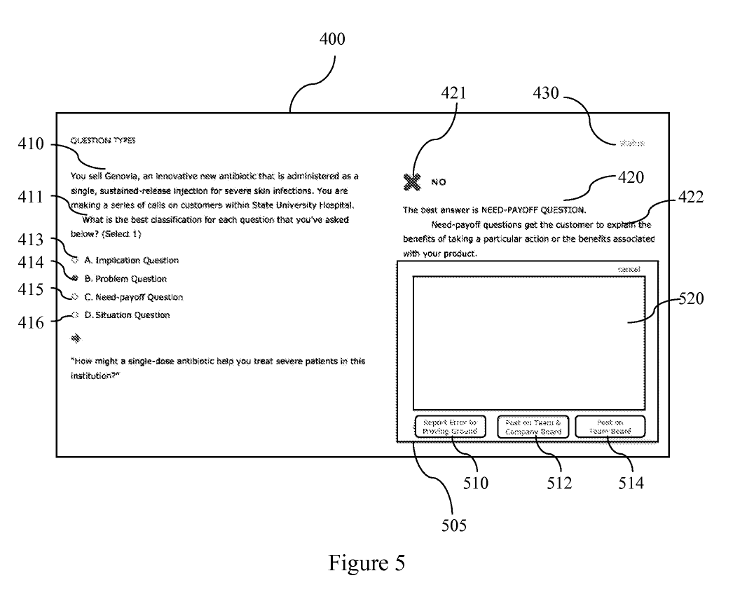

User comments and/or discussions submitted using the interactive feature 505 may be categorized by the training system 100 to facilitate communication between users on specific topics such as study area, case study, skill, simulation, test question, and the like. User comments and/or discussions submitted using the interactive feature 505 may be displayed to any appropriate user of the testing system 100. For example, referring now to FIG. 6, the testing system may present an interactive summary window 605 providing a summary 610 of required job tasks 615 that must be completed by a user. For example, a job task 615 may comprise a training course, may comprise a floor of a training course, or may comprise a skill. The summary 610 may provide a breakdown of the tasks 615 and the level of completion for each task by the user, team, and/or group. The level of completion may comprise a game score, a floor score, and/or a habit score. The user may be able to access and/or take part in discussions associated with a particular task by clicking on the desired task 615. For example, by clicking on, or otherwise selecting a given task 615, the user may be presented with a comment window 620 containing comments from one or more users concerning the task 615 and/or discussions between users regarding the task 615. The user may be able to view comments and discussions, and may be able to actively take part in a discussion by adding their own thoughts, perspectives, experiences, and the like.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method of training a user by a computer having access to a memory, comprising:
initializing a score;
selecting a multiple choice question from a pool of multiple choice questions;
administering the multiple choice question by the computer, wherein administering the multiple choice question comprises:
presenting the multiple choice question, wherein presenting the multiple choice question comprises:
presenting the case study and potential answers of the multiple choice question when the score is below a first predetermined score threshold; and
presenting the case study of the multiple choice question and hiding the potential answers of the multiple choice question from the user when the score is greater than or equal to the first predetermined threshold, wherein each of the potential answers of the multiple choice question and an icon associated with each of the potential answers are presented for at most a first predetermined amount of time when the user indicates that the answer choices should be presented; and
receiving a user answer selection;
determining, based on the user answer selection and by the computer, whether the user answered the multiple choice question correctly;
updating the score, by the computer, by determining a number of administered multiple choice questions from the pool that were answered correctly; and
ending the training of the user only when the score is greater than or equal to a second predetermined score threshold.

2. A method for training a user according to claim 1, wherein:
a second predetermined number of multiple choice questions are selected and administered before the ending the training of the user.

3. A method for training a user according to claim 2, wherein:
the pool comprises one or more introductory multiple choice questions and one or more non-introductory multiple choice questions;
the second predetermined number of multiple choice questions comprises a fourth predetermined number of introductory multiple choice questions; and
introductory multiple choice questions administered after the fourth predetermined number of multiple choice questions have been administered do not affect the score.

4. A method for training a user according to claim 2, further comprising:
initializing a second score;
selecting a second predetermined number of multiple choice questions from a second pool of multiple choice questions;
administering the second predetermined number of multiple choice questions from a second pool of multiple choice questions;
determining, by the computer, whether the user answered the administered multiple choice questions from the second pool correctly;
updating the second score, by the computer, by determining a number of administered multiple choice questions from the second pool that were answered correctly; and
ending the training only when both the first score and the second score are greater than or equal to the second predetermined score threshold.

5. A method for training a user according to claim 4, wherein the correct answer choice for each multiple choice question is associated with a skill and each skill is associated with an icon, and further comprising:
initializing a habit score for the skill;
updating the habit score, by the computer, by determining a number of administered multiple choice questions having a correct answer choice associated with the skill that were answered correctly; and
representing the habit score using the icon.

6. A method for training a user according to claim 1, wherein:
the first predetermined score threshold is 60%; and
the second predetermined score threshold is 80%.

7. A method for training a user according to claim 1, wherein the correct answer choice for each multiple choice question is associated with a skill and each skill is associated with an icon, and further comprising:
initializing a habit score for the skill;
updating the habit score, by the computer, by determining a number of administered multiple choice questions having a correct answer choice associated with the skill that were answered correctly; and
representing the habit score using the icon.

8. A method for training a user according to claim 1, wherein:
the multiple choice question is presented for at most a second predetermined amount of time.

9. A computer system comprising a processor, and a memory responsive to the processor, wherein the memory stores instructions configured to cause the processor to:
initialize a score;
select a multiple choice question from a pool of multiple choice questions;
administer the multiple choice question, wherein administering the multiple choice question comprises:
presenting the multiple choice question, wherein presenting the multiple choice question comprises:
presenting the case study and potential answers of the multiple choice question when the score is below a first predetermined score threshold; and
presenting the case study of the multiple choice question and hiding the potential answers of the multiple choice question from the user when the score is greater than or equal to the first predetermined threshold, wherein each of the potential answers of the multiple choice question and an icon associated with each of the potential answers are presented for at most a first predetermined amount of time when the user indicates that the answer choices should be presented; and
receiving a user answer selection;
determine, based on the user answer selection, whether the user answered the multiple choice question correctly;
update the score by determining a number of administered multiple choice questions from the pool that were answered correctly; and
end the training of the user only when the score is greater than or equal to a second predetermined score threshold.

10. A computer system according to claim 9, wherein:
a second predetermined number of multiple choice questions are selected and administered before the ending the training of the user.

11. A computer system according to claim 10, wherein:
the pool comprises one or more introductory multiple choice questions and one or more non-introductory multiple choice questions;
the second predetermined number of multiple choice questions comprises a fourth predetermined number of introductory multiple choice questions; and
introductory multiple choice questions administered after the fourth predetermined number of multiple choice questions have been administered do not affect the score.

12. A computer system according to claim 10, wherein the instructions are further configured to cause the processor to:
initialize a second score;
select a second predetermined number of multiple choice questions from a second pool of multiple choice questions;
administer the second predetermined number of multiple choice questions from a second pool of multiple choice questions;
determine whether the user answered the administered multiple choice questions from the second pool correctly;
update the second score by determining a number of administered multiple choice questions from the second pool that were answered correctly; and
end the training only when both the first score and second score are greater than or equal to the second predetermined score threshold.

13. A computer system according to claim 12, wherein the correct answer choice for each multiple choice question is associated with a skill and each skill is associated with an icon, and wherein the instructions are further configured to cause the processor to:
initialize a habit score for the skill;
update the habit score by determining a number of administered multiple choice questions having a correct answer choice associated with the skill that were answered correctly; and
represent the habit score using the icon.

14. A computer system according to claim 9, wherein:
the first predetermined score threshold is 60%; and
the second predetermined score threshold is 80%.

15. A computer system according to claim 9, wherein the correct answer choice for each multiple choice question is associated with a skill and each skill is associated with an icon, and wherein the instructions are further configured to cause the processor to:
initialize a habit score for the skill;
update the habit score by determining a number of administered multiple choice questions having a correct answer choice associated with the skill that were answered correctly; and
represent the habit score using the icon.

16. A computer system according to claim 9, wherein:
the multiple choice question is presented for at most a second predetermined amount of time.

17. A non-transitory computer-readable medium storing computer-executable instructions for training a user, wherein the instructions are configured to cause a computer to:
initialize a score;
select a multiple choice question from a pool of multiple choice questions;
administer the multiple choice question, wherein administering the multiple choice question comprises:
presenting the multiple choice question, wherein presenting the multiple choice question comprises:
presenting the case study and potential answers of the multiple choice question when the score is below a first predetermined score threshold; and
presenting the case study of the multiple choice question and hiding the potential answers of the multiple choice question from the user when the score is greater than or equal to the first predetermined threshold, wherein each of the potential answers of the multiple choice question and an icon associated with each of the potential answers are presented for at most a first predetermined amount of time when the user indicates that the answer choices should be presented; and
receiving a user answer selection;
determine, based on the user answer selection, whether the user answered the multiple choice question correctly;
update the score by determining a number of administered multiple choice questions from the pool that were answered correctly; and
end the training of the user only when the score is greater than or equal to a second predetermined score threshold.

18. A non-transitory computer-readable medium according to claim 17, wherein:
a second predetermined number of multiple choice questions are selected and administered before the ending the training of the user.

19. A non-transitory computer-readable medium according to claim 18, wherein:
the pool comprises one or more introductory multiple choice questions and one or more non-introductory multiple choice questions;
the second predetermined number of multiple choice questions comprises a fourth predetermined number of introductory multiple choice questions; and
introductory multiple choice questions administered after the fourth predetermined number of multiple choice questions have been administered do not affect the score.

20. A non-transitory computer-readable medium according to claim 18, wherein the computer-executable instructions are further configured to cause the computer to:
initialize a second score;
select a second predetermined number of multiple choice questions from a second pool of multiple choice questions;
administer the second predetermined number of multiple choice questions from a second pool of multiple choice questions;
determine whether the user answered the administered multiple choice questions from the second pool correctly;
update the second score by determining a number of administered multiple choice questions from the second pool that were answered correctly; and
end the training only when both the first score and second score are greater than or equal to the second predetermined score threshold.

21. A non-transitory computer-readable medium according to claim 20, wherein the correct answer choice for each multiple choice question is associated with a skill and each skill is associated with an icon, and wherein the computer-executable instructions are further configured to cause the computer to:
initialize a habit score for the skill;
update the habit score by determining a number of administered multiple choice questions having a correct answer choice associated with the skill that were answered correctly; and
represent the habit score using the icon.

22. A non-transitory computer-readable medium according to claim 17, wherein:
the first predetermined score threshold is 60%; and
the second predetermined score threshold is 80%.

23. A non-transitory computer-readable medium according to claim 17, wherein the correct answer choice for each multiple choice question is associated with a skill and each skill is associated with an icon, and wherein the computer-executable instructions are further configured to cause the computer to:
initialize a habit score for the skill;
update the habit score by determining a number of administered multiple choice questions having a correct answer choice associated with the skill that were answered correctly; and
represent the habit score using the icon.

24. A non-transitory computer-readable medium according to claim 17, wherein:
the multiple choice question is presented for at most a second predetermined amount of time.
